(19) United States
(12) Patent Application Publication
(10) Pub. No.: US 2002/0012013 A1
(43) Pub. Date: Jan. 31, 2002

(54) 3-dimensional model-processing apparatus, 3-dimensional model-processing method and program-providing medium

(76) Inventors: Yuichi Abe, Tokyo (JP); Hiroyuki Segawa, Kanagawa (JP); Hiroyuki Shioya, Tokyo (JP); Norikazu Hiraki, Tokyo (JP)

Correspondence Address: Bell, Boyd & Lloyd LLC, P.O. Box 1135, Chicago, IL, 60690-1135, US

(21) Appl. No.: 09/860,337

(22) Filed: May 18, 2001

(30) Foreign Application Priority Data
May 18, 2000 (JP) P2000-145983

(51) Int. Cl. G06T 15/00

(52) U.S. Cl. 345/764; 345/419

(57) ABSTRACT

A 3-dimensional-model-processing apparatus for carrying out processing to change information on surfaces of a 3-dimensional model serving as an object of editing appearing on picture display means on the basis of information on 3-dimensional positions which is obtained from a 3-dimensional sensor comprising control means for executing control of processing carried out on the 3-dimensional model serving as an object of editing by using an editing tool appearing on the picture display means, wherein the control means allows attributes of the editing tool to be changed and carries out processing to change the information on surfaces of the 3-dimensional model serving as an object of editing in accordance with the changed attributes of the editing tool.

### BACKGROUND OF THE INVENTION

The present invention relates to a 3-dimensional model-processing apparatus, a 3-dimensional model-processing method and a program-providing medium. More particularly, the present invention relates to processing to change information on surfaces of a 3-dimensional model displayed on a graphic system. To be more specific, the present invention relates to a 3-dimensional model-processing apparatus and a 3-dimensional model-processing method which allow the operator to intuitively carry out processing to change information on surfaces of a 3-dimensional model object displayed on a display unit of a PC, a CAD system or the like, such as colors of the 3-dimensional model object. Thus, the present invention allows processing with improved operatability.

Representatives of object processing carried out by conventional 3-dimensional model graphic systems include processing to change information on surfaces of an object, such as colors of the object. Technologies to change information on surfaces of an object of editing on a computer functioning as a picture-processing system, such as a PC and a CAD tool, include software for paint processing in the field of computer graphics. In most of the contemporary 3-dimensional model systems, information on surfaces of an object of editing is changed by operating an editing tool and/or the object separately by using a mouse or a 2-demensional tablet in the same way as editing a 2-demensional picture, even if the object is a 3-dimensional model.

As a configuration dedicated to object processing of a 3-dimensional model, research of virtual reality implements a system for changing information on surfaces of an object of editing by operating the object and operating an editing tool by means of a 3-dimensional input unit of a glove type.

The conventional technologies cited above have the following problems. Since 2-demensional information is entered by using a mouse or a 2-demensional tablet used in most of contemporary 3-dimensional systems even in an operation of a 3-dimensional object appearing on a display unit, cumbersome processing is required, for example, in order to move the object. The operation of the object is typically an operation to add a pattern to a location on a desired surface of the object or to give a color to the location. In order to expose the surface to the operator, the operator may need to change the orientation of the object or rotate the object.

In addition, while an operation to enter information to a 3-dimensional input device of the glove type is generally thought to be intuitive, in actuality, it is necessary to carry out the operation in accordance with certain requirements as to which actual operation is required and what selection process is needed. The selection process is carried out to determine whether or not it is desired to change information on surfaces of an object. Thus, complicated procedures, such as determination of processing execution and determination of processing implementation, need to be executed as gestures in accordance to rules. As a result, it is difficult to carry out processing intuitively. Furthermore, the price of an input unit of the glove type is expensive, making it difficult for a general user to easily own such an input unit. Moreover, if the 3-dimensional system is applied to a commodity for small children, the size of the glove-type input device must be changed to the size of hand of the child which is much smaller than that of an adult.

As described above, with the conventional 3-dimensional-model-processing apparatus, it can be difficult for the operator to intuitively operate various kinds of processing on a 3-dimensional model to be processed even though the processing is made possible. In other words, the input means can be improved to be operated more intuitively.

### SUMMARY OF THE INVENTION

An advantage of the present invention, addressing shortcomings of the conventional technologies described above, is to provide a 3-dimensional-model-processing apparatus and 3-dimensional model-processing method which allow processing of a 3-dimensional model to be carried out intuitively by eliminating complicated processing rules so that even a beginner unfamiliar with the 3-dimensional-model-processing system is capable of using the system.

According to an embodiment of the present invention, a 3-dimensional-model-processing apparatus is provided for carrying out processing to change information on surfaces of a 3-dimensional model serving as an object of editing appearing on picture display means on the basis of information on 3-dimensional positions which is obtained from a 3-dimensional sensor including, control means for executing control of processing carried out on the 3-dimensional model serving as an object of editing by using an editing tool appearing on the picture display means, wherein the control means allows attributes of the editing tool to be changed and carries out processing to change the information on surfaces of the 3-dimensional model serving as an object of editing in accordance with the changed attributes of the editing tool.

The control means preferably executes control to store the changed attribute data of the editing tool in memory, change object attribute data representing the information on surfaces of the object of editing in accordance with the attribute data of the editing tool stored in the memory, and execute a rendering operation to display the 3-dimensional model serving as the object of editing on the basis of the changed object attribute data on the picture display means.

The control means preferably controls processing in two modes including an attribute-changing mode for changing attributes of the editing tool and a surface-information-changing mode for changing the information on surfaces of the 3-dimensional model serving as an object of editing. In the attribute-changing mode, a menu for setting attributes of the editing tool is displayed on the picture display means and processing is carried out to store attribute-setting data entered via input means in memory. In surfaces-information-changing mode, the 3-dimensional model serving as an edited mode is displayed on the picture display means, object attribute data representing the information on surfaces of the 3-dimensional model serving as an object of editing is changed in accordance with the attribute-setting data stored in the memory to represent attributes of the editing tool, and a rendering operation based on the changed object attribute data is carried out to display the 3-dimensional model serving as an object of editing on the picture display unit.

The control means preferably executes control for making a processing operation point of the editing tool movable and constrained at positions on surfaces of the 3-dimensional model serving as an object of editing being processed.

Preferably, the editing tool is a brush tool for changing the information on surfaces of the 3-dimensional model serving as an object of editing and, the editing tool is capable of setting at least one of its attributes, including a color, a pattern, a shape, a thickness and a type, at different values.

Preferably, the editing tool is a spray tool for changing the information on surfaces of the 3-dimensional model serving as an object of editing, and the editing tool is capable of setting at least one of its attributes, including a color, a pattern, a particle generation rate, a particle shape and a distance, angle and shape of an operating area, at different values.

Preferably the editing tool is a pasting tool for changing the information on surfaces of the 3-dimensional model serving as an object of editing, and the editing tool is capable of setting data of a picture to be pasted as its attribute at different values.

According to an embodiment of the present invention, a 3-dimensional-model-processing method is provided for carrying out processing to change information on surfaces of a 3-dimensional model serving as an object of editing appearing on picture display means on the basis of information on 3-dimensional positions which is obtained from a 3-dimensional sensor, by using an editing tool appearing on the picture display means, the 3-dimensional-model-processing method including the steps of changing attributes of the editing tool, and carrying out processing to change the information on surfaces of the 3-dimensional model serving as an object of editing in accordance with the changed attributes of the editing tool.

Preferably, the step of changing attributes of the editing tool includes the step of storing the changed attribute data of the editing tool in memory, and the step of carrying out processing to change the information on surfaces of the 3-dimensional model changes object attribute data representing the information on surfaces of the object of editing in accordance with the attribute data of the editing tool stored in the memory, and carries out a rendering operation to display the 3-dimensional model serving as the object of editing on the basis of the changed object attribute data on the picture display means.

Preferably, at the step of changing attributes of the editing tool, a menu for setting attributes of the editing tool is displayed on the picture display means and processing is carried out to store attribute-setting data entered via input means in memory, and at the step of carrying out processing to change the information on surfaces of the 3-dimensional model, the 3-dimensional model serving as an edited mode is displayed on the picture display means, object attribute data representing the information on surfaces of the 3-dimensional model serving as an object of editing is changed in accordance with the attribute-setting data stored in the memory to represent attributes of the editing tool, and a rendering operation based on the changed object attribute data is carried out to display the 3-dimensional model serving as an object of editing on the picture display unit.

Preferably, control is executed for making a processing operation point of the editing tool movable and constrained at positions on surfaces of the 3-dimensional model serving as an object of editing.

According to another embodiment of the present invention, a program-providing medium is provided for providing a computer program to a computer system to be executed by the computer system for carrying out processing to change information on surfaces of a 3-dimensional model serving as an object of editing appearing on picture display means on the basis of information on 3-dimensional positions which is obtained from a 3-dimensional sensor, by using an editing tool appearing on the picture display means, the computer program including the steps of changing attributes of the editing tool, and carrying out processing to change the information on surfaces of the 3-dimensional model serving as an object of editing in accordance with the changed attributes of the editing tool.

The program-providing medium according to this embodiment of the present invention is a medium for providing a computer program in a computer-readable format to a general-purpose computer capable of executing a variety of programs and codes. Examples of the program-providing medium are a storage medium such as a CD (compact disc), an FD (floppy disc) or an MO (magneto-optical) disc and a transmission medium such as a network. The format of the program-providing medium is not prescribed in particular.

Such a program-providing medium defines a structural and functional cooperative relation between the computer program and the providing medium to implement predetermined fimctions of the computer program on the general-purpose computer system. In other words, by installation of the computer program from the program-providing medium in the general-purpose computer system, effects of collaboration can be displayed on the computer system and the same effects as the other aspects of the present invention can thus be obtained.

Other objects, features and merits of the present invention will probably become apparent from the following detailed description of preferred embodiments of the present invention with reference to accompanying diagrams.

### BRIEF DESCRIPTION OF THE DRAWINGS

FIG. 1 is an explanatory diagram showing an outline of operations carried out by the operator on a 3-dimensional-model-processing apparatus provided by the present invention;

FIG. 2 is a block diagram showing a hardware configuration of the 3-dimensional-model-processing apparatus provided by the present invention;

FIG. 3 is a flowchart representing processing to switch an operating mode from a surface-information-changing mode to an attribute-changing mode and vice versa in the 3-dimensional-model-processing apparatus provided by the present invention;

FIG. 4 is a flowchart representing a subroutine of using a brush tool for changing information on surfaces of an object of editing in the 3-dimensional-model-processing apparatus provided by the present invention;

FIGS. 5A through 5C are explanatory diagrams each showing an outline of processing to move a surface point set as an operating point in the 3-dimensional-model-processing apparatus provided by the present invention;

FIG. 6 shows a flowchart representing a surface-point subroutine for setting a surface point for an operating point in the 3-dimensional-model-processing apparatus provided by the present invention;

FIG. 7 shows a flowchart representing a surface-point-generating subroutine of the 3-dimensional-model-processing apparatus provided by the present invention;

FIGS. 8A through 8C are diagrams each showing a model applicable to the flowchart representing the surface-point-generating subroutine in the 3-dimensional-model-processing apparatus provided by the present invention;

FIG. 9 is a flowchart representing a surface-point-updating subroutine of the 3-dimensional-model-processing apparatus provided by the present invention;

FIGS. 10A and 10B are diagrams each showing a model applicable to the surface-point-updating subroutine of the 3-dimensional-model-processing apparatus provided by the present invention;

FIG. 11 is a flowchart representing a tool-attribute-changing subroutine for changing an attribute of a brush tool in the 3-dimensional-model-processing apparatus provided by the present invention;

FIG. 12 is another flowchart representing a tool-attribute-changing subroutine for changing an attribute of a brush tool in the 3-dimensional-model-processing apparatus provided by the present invention;

FIG. 13 is a diagram showing an implementation of processing by a brush tool in the 3-dimensional-model-processing apparatus provided by the present invention;

FIG. 14 is a diagram showing another implementation of the processing by a brush tool in the 3-dimensional-model-processing apparatus provided by the present invention;

FIG. 15 is a diagram showing a set of menu display items used in processing to change an attribute of a brush tool in the 3-dimensional-model-processing apparatus provided by the present invention;

FIG. 16 is a diagram showing another menu display item used in processing to change an attribute of a brush tool in the 3-dimensional-model-processing apparatus provided by the present invention;

FIG. 17 is a flowchart representing a subroutine of using a spray tool for changing information on surfaces of an object of editing in the 3-dimensional-model-processing apparatus provided by the present invention;

FIG. 18 is a diagram showing the configuration of an embodiment implementing a spray tool used in the 3-dimensional-model-processing apparatus provided by the present invention;

FIG. 19 is an explanatory diagram showing processing which is carried out when a plurality of object surfaces exists in an operating area of a spray tool in the 3-dimensional-model-processing apparatus provided by the present invention;

FIGS. 20A and 20B are diagrams showing processing results varying due to a difference in particle density which can be set as an attribute of a spray tool in the 3-dimensional-model-processing apparatus provided by the present invention;

FIG. 21 is a diagram showing processing with a setting of a particle shape which can be set as an attribute of a spray tool in the 3-dimensional-model-processing apparatus provided by the present invention;

FIG. 22 is a diagram showing another processing with a setting of a particle shape which can be set as an attribute of a spray tool in the 3-dimensional-model-processing apparatus provided by the present invention;

FIG. 23 is a diagram showing processing using a spray tool in the 3-dimensional-model-processing apparatus provided by the present invention;

FIG. 24 is a diagram showing a list of menu display items used in selecting an attribute of a spray tool in the 3-dimensional-model-processing apparatus provided by the present invention;

FIG. 25 is a flowchart representing a subroutine of using a pasting tool for changing information on surfaces of an object of editing in the 3-dimensional-model-processing apparatus provided by the present invention;

FIG. 26 is a diagram showing processing using a pasting tool in the 3-dimensional-model-processing apparatus provided by the present invention; and

FIG. 27 is a diagram showing a list of menu display items used in selecting an attribute of a pasting tool in the 3-dimensional-model-processing apparatus provided by the present invention.

### DETAILED DESCRIPTION OF THE INVENTION PREFERRED EMBODIMENTS OF THE INVENTION

The following description explains preferred embodiments implementing a 3-dimensional-model-processing apparatus and a 3-dimensional-model-processing method, which are provided by the present invention, in detail.

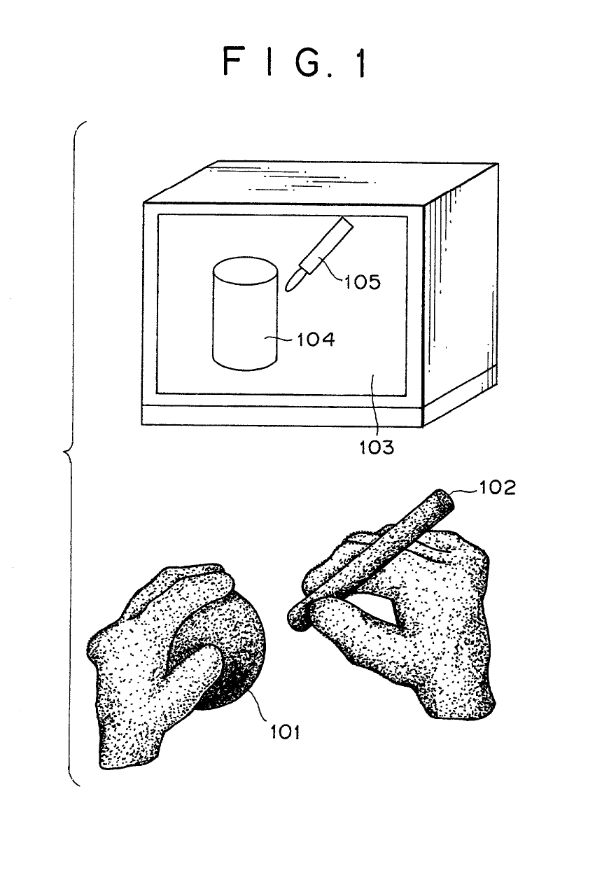

The description begins with an explanation of an outline of processing carried out by the 3-dimensional model-processing apparatus provided by the present invention to change information on surfaces of an object of editing. A 3-dimensional-model-processing system has a configuration like one shown in FIG. 1. The 3-dimensional-model-processing system shown in FIG. 1 is a system which is capable of changing information on the position as well as the posture of an object of editing 104 appearing on a picture display unit 103 and the position as well as the posture of an editing tool 105 also appearing on the picture display unit 103 when the user freely operates 2 sensors, namely, a 3-dimensional position and angle sensor 101 assigned to the object of editing 104 and a 3-dimensional position and angle sensor 102 assigned to the editing tool 105. The 3-dimensional-model-processing system changes information on surfaces of the object of editing 104 on the basis of the position and the angle of the editing tool 105 relative to the object of editing 104.

The editing tool 105 is provided with functions for changing information on surfaces of the object of editing 104. The functions include a function of a spray for roughly giving a color to a surface of the object of editing 104, a function of a brush for giving a color to a fine portion on the surface of the object of editing 104, and a function for pasting a 2-demensional picture prepared in advance on the surface of the object of editing 104, for example. These functions can be changed by the user. In addition, attributes of a brush, such as the color and the thickness of the brush, can be set. Their details will be described later.

The editing tool 105 appearing on the picture display unit 103 shown in FIG. 1 is an editing tool having a shape and a function which are similar to those of a brush. When the outlet of the editing tool 105 is brought into contact with the surface of the object of editing 104, the user is capable of giving a color to the surface by carrying out an intuitive operation as if an actual brush were used.

Information on the position and the posture of the editing tool 105 appearing on the picture display unit 103 is changed by operating the 3-dimensional position and angle sensor 102. By the same token, information on the position and the posture of the object of editing 104 appearing on the picture display unit 103 is changed by operating the 3-dimensional position and angle sensor 101. Typically, the 3-dimensional position and angle sensor 101 and the 3-dimensional position and angle sensor 102 are each a magnetic or ultrasonic sensor generating information on a position and a posture as a magnetic field or an ultrasonic wave respectively. It should be noted that, if it is not necessary to move the object of editing 104, the 3-dimensional position and angle sensor 101 is not necessarily required either. In this case, only the editing tool 105 is operated to carry out, for example, processing to paint the object of editing 104, the position of which is fixed.

In the following description, an editing tool having a function like that of a spray is referred to as a spray tool, and an editing tool with a function like that of a brush is referred to as a brush tool. An editing tool having a function for pasting a 2-dimensional picture prepared in advance on the surface of the object of editing 104 is referred to as a pasting tool. These 3 editing tools are exemplified. The explanation begins with a description of a portion common to the brush tool, the spray tool and the paste tool to be followed by descriptions of different kinds of processing carried out by the editing tools in the following order: the brush tool, the spray tool and the paste tool.

Portion Common to the Editing Tools

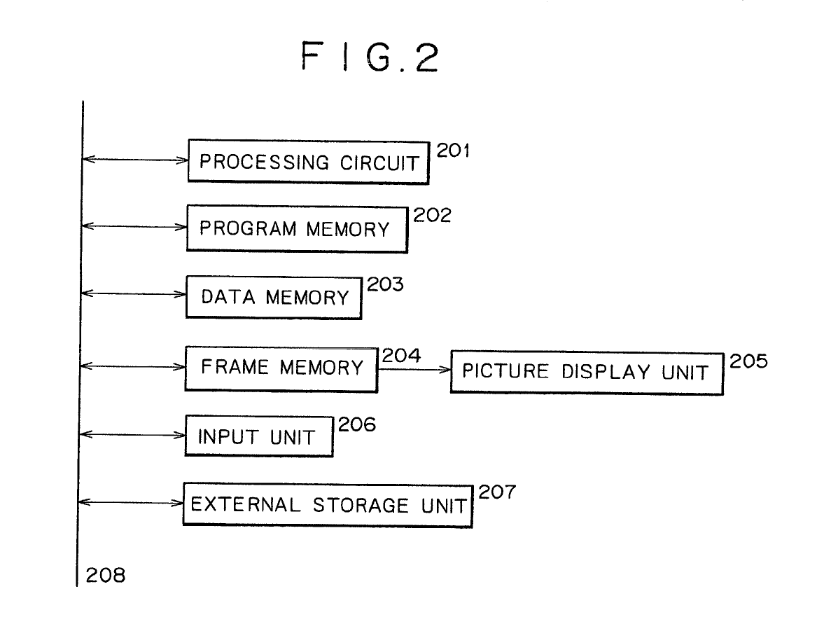

FIG. 2 is a block diagram of pieces of main hardware composing a 3-dimensional-model-processing system to which the 3-dimensional-model-processing apparatus and 3-dimensional-model-processing method of the present invention can be applied. As shown in FIG. 2, the 3-dimensional-model-processing system comprises main components such as a processing circuit 201, a program memory 202, a data memory 203, a frame memory 204, a picture display unit 205, an input unit 206, and an external storage unit 207. The processing circuit 201, the program memory 202, the data memory 203, the frame memory 204, the input unit 206, and the external storage unit 207 are connected to each other by a bus 208 in a configuration allowing data to be exchanged among them through the bus 208.

The processing circuit 201 is used for carrying out, among other processes, processing to read processing data from the data memory 203 and update information on surfaces of an object of editing by execution of a program stored in the program memory 202 in accordance with input data entered via the input unit 206. The processing circuit 201 also generates picture information for rendering the object of editing and the editing tool or a command given to the user, and storing the information in the frame memory 204. The picture display unit 205 shows a picture, the information on which is stored in the frame memory 204. Programs and data are transferred through the bus 208.

The object of editing is typically a 3-dimensional model. In this case, the data memory 203 is used for storing various kinds of information on the 3-dimensional model. The information includes information on the position and the posture of the 3-dimensional model and information on surfaces of the model. Examples of the information on a 3-dimensional model are information on polygon or voxel expression and information on free-curved surfaces, such as an NURBS.

The picture display unit 205 is used for displaying a 3-dimensional model serving as an object of editing and an editing tool for carrying out various kinds of processing such as painting of the object. An example of the editing tool is a select pointer.

The input unit 206 is typically a 3-dimensional sensor for operating, for example, the 3-dimensional model shown in FIG. 1. The 3-dimensional sensor is operated to generate information on the position and the posture of the 3-dimensional model. The information is supplied to the processing circuit 201 as input data. The 3-dimensional sensor is a magnetic or ultrasonic sensor generating information on a position and a posture as a magnetic field or an ultrasonic wave respectively. In addition, the 3-dimensional sensor may also be provided with a button for entering a command such as an instruction to start or stop processing.

The external storage unit 207 is a unit for storing programs and information on a 3-dimensional model. As the external storage unit 207, it is desirable to use a hard disc driven by the HDD (hard-disc drive) or a randomly accessible storage medium such as an optical disc. However, it is also possible to use a randomly non-accessible storage medium such as a tape streamer or a non-volatile semiconductor memory represented by a memory stick. It is even possible to use the external storage medium of another system connected by a network. As an alternative, a combination of these devices can also be used.

In the present invention, information on surfaces of an object is changed by using a relation between the positions of the object of editing and an editing tool. That is to say, the information on surfaces of an object of editing is changed in accordance with attributes of the editing tool. In the case of an editing tool for carrying out processing to change a color as the information on a surface of an object of editing or a tool for giving a color to the surface of the object of editing, for example, attributes of the tool are information on coloring, such as a color, a pattern and a shape. If the color attribute of the editing tool is a red color, for example, the red color is given to a surface of the object of editing. In addition, if the pattern attribute of the editing tool is a lattice, the surface of the object is painted with a red lattice.

In addition, the 3-dimensional-model-processing system provided by the present invention allows processing to be carried out to change an attribute of an editing tool. By changing attributes of the editing tool, surfaces of an object of editing are painted with different colors in a variety of patterns. Thus, operations of the present invention can be classified into the following 2 categories. The first category includes operations to change information on surfaces of an object of editing by using an editing tool. On the other hand, the second category includes operations to modify attributes of the editing tool. The operations of the first category are carried out in a surface-information-changing mode while those of the second category are performed in an attribute-changing mode.

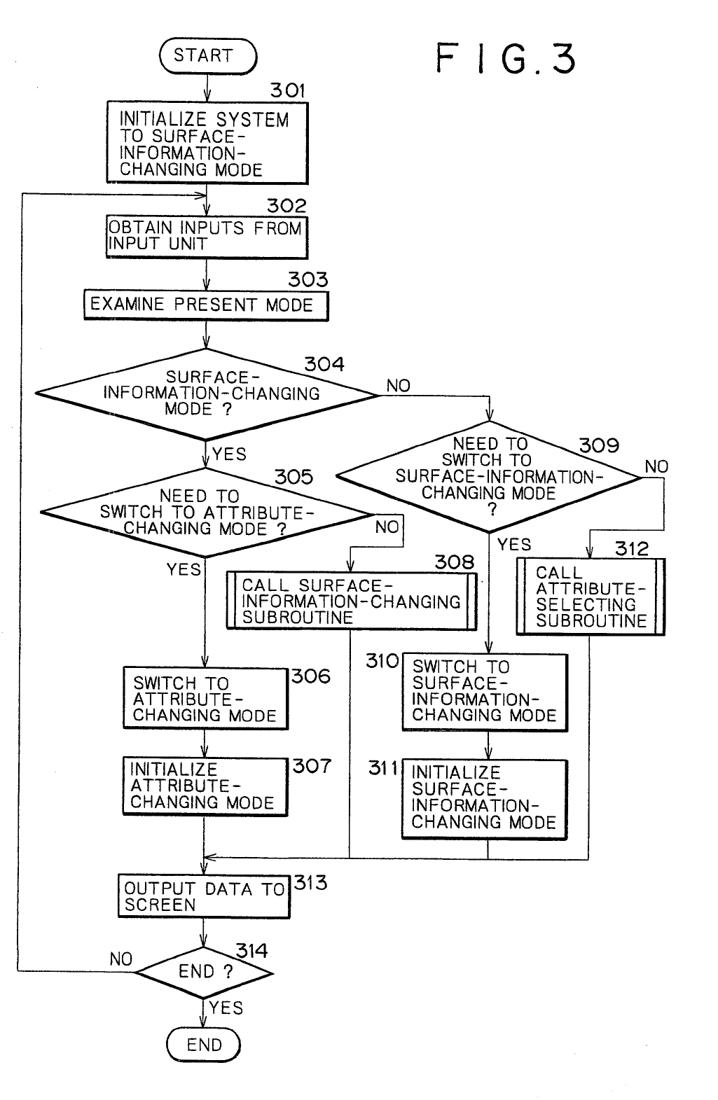

FIG. 3 is a flowchart representing processing to switch an operating mode from a surface-information-changing mode to an attribute-changing mode and vice versa. As shown in the figure, the flowchart begins with a step 301 at which the operating mode is initialized to a surface-information-changing mode as a present mode. In the initialization, the computer generates data representing the shape of an object to be edited and data representing the shape of an editing tool. These pieces of data are required in 3-dimensional-model processing such as processing to change information on surfaces of the object of editing and processing to change attributes of the editing tool. The data representing the shape of an editing tool does not have to be data representing a 3-dimensional shape. Instead, the data representing the shape of an editing tool can be data representing a 2-demensional shape if necessary.

At the next step 302, information on the position as well as the posture of the object to be edited and information on the position as well as the posture of the editing tool are obtained from the input unit 206.

At the next step 303, the present mode is examined. The flow of the processing then goes on to a step 304 to form a judgment as to whether or not the present mode is the surface-information-changing mode. If the present mode is the surface-information-changing mode, the flow of the processing goes on to a step 305. If the present mode is not the surface-information-changing mode, on the other hand, the flow of the processing goes on to a step 309.

At the step 305, the information acquired at the step 302 is examined to form a judgment as to whether or not it is necessary to switch the surface-information-changing mode to the attribute-changing mode. If it is necessary to switch the surface-information-changing mode to the attribute-changing mode, the flow of the processing goes on to a step 306. If it is not necessary to switch the surface-information-changing mode to the attribute-changing mode, on the other hand, the flow of the processing goes on to a step 308 at which processing is carried out to change information on surfaces of the object of editing.

The information acquired at the step 302 may represent a special operation determined in advance to switch the surface-information-changing mode to the attribute-changing mode. An example of such a special operation is an operation to press a mode-switching button of the input unit 206. Another example is an operation to press a button of the input unit 206 after the editing tool has moved to a predetermined location.

At the step 306, the surface-information-changing mode is switched to the attribute-changing mode. In the operation to switch the surface-information-changing mode to the attribute-changing mode, the surface-information-changing mode's information on the object of editing and information on the editing tool are stored into the data memory 203 or the external storage unit 207 in some cases. As a result, data representing the object of editing and the editing tool disappears from a 3-dimensional space appearing on the picture display unit 205. As an alternative, only the data is held but the data on the picture display unit 205 only is put in a non-display state. By storing information on the current states of the object of editing and the editing tool into the data memory 203, the information can be retrieved back from the data memory 203 later to restore the state prior to the operation to switch the surface-information-changing mode to the attribute-changing mode in case the mode needs to be switched back to the surface-information-changing mode.

At the next step 307, the attribute-changing mode is initialized. In the initialization, items each representing a changeable attribute of the editing tool and a cursor for selecting one of the items are generated. The items are each referred to hereafter as an attribute menu display item. Referred to hereafter as a select pointer, the cursor is capable of moving 3-dimensionally.

At the step 309, the information acquired at the step 302 is examined to form a judgment as to whether or not it is necessary to switch the attribute-changing mode to the surface-information-changing mode. If it is necessary to switch the attribute-changing mode to the surface-information-changing mode, the flow of the processing goes on to a step 310. If it is not necessary to switch the attribute-changing mode to the surface-information-changing mode, on the other hand, the flow of the processing goes on to a step 312 at which processing is carried out to change attributes of the editing tool.

The information acquired at the step 302 may represent a special operation determined in advance to switch the attribute-changing mode to the surface-information-changing mode. An example of such a special operation is an operation to press the mode-switching button of the input unit 206. Another example is an operation of pressing a confirmation button of the input unit 206 to confirm that an attribute of the editing tool is to be changed to another attribute selected by an attribute-selecting subroutine.

At the step 310, the attribute-changing mode is switched to the surface-information-changing mode. In the operation to switch the attribute-changing mode to the surface-information-changing mode, an attribute of the editing tool is replaced by an attribute selected by the attribute-selecting subroutine and stored into the data memory 203 or the external storage unit 207 in some cases. Then, an attribute menu display item and the select pointer are deleted. If no attribute of the editing tool is selected, on the other hand, no attribute is changed. Also in this case, however, the set of attribute menu display items and the select pointer are deleted as well.

At the next step 311, information on the surface-information-changing mode is retrieved from the data memory 203 and used for generating data. The information was stored in the data memory 203 before the mode switching. The data is used for displaying the object of editing and the editing tool on the picture display unit 205. If an attribute of the editing tool has been changed, the change is reflected in the display.

At the next step 313, items that need to be displayed are rendered and picture information is stored in the frame memory 204 to be eventually output to the picture display unit 205. The flow of the processing then goes on to a step 314 to form a judgment as to whether or not the loop of the processing is to be repeated. If the loop of the processing is to be repeated, the flow of the processing goes back to the step 302. If the loop of the processing is not to be repeated, on the other hand, the processing is merely ended. The processing is ended typically by a command entered by the user or in accordance with a rule set for the application. An example of the rule is a game-over event in the case of a game application. The processing may also be ended typically by a limitation imposed by hardware or software. An example of the limitation imposed by hardware is a full-memory state.

A surface-information-changing subroutine called at the step 308 and an attribute-changing subroutine called at the step 312 are explained for a variety of editing tools in the following order: the brush tool, the spray tool, and the pasting tool.

Brush Tools

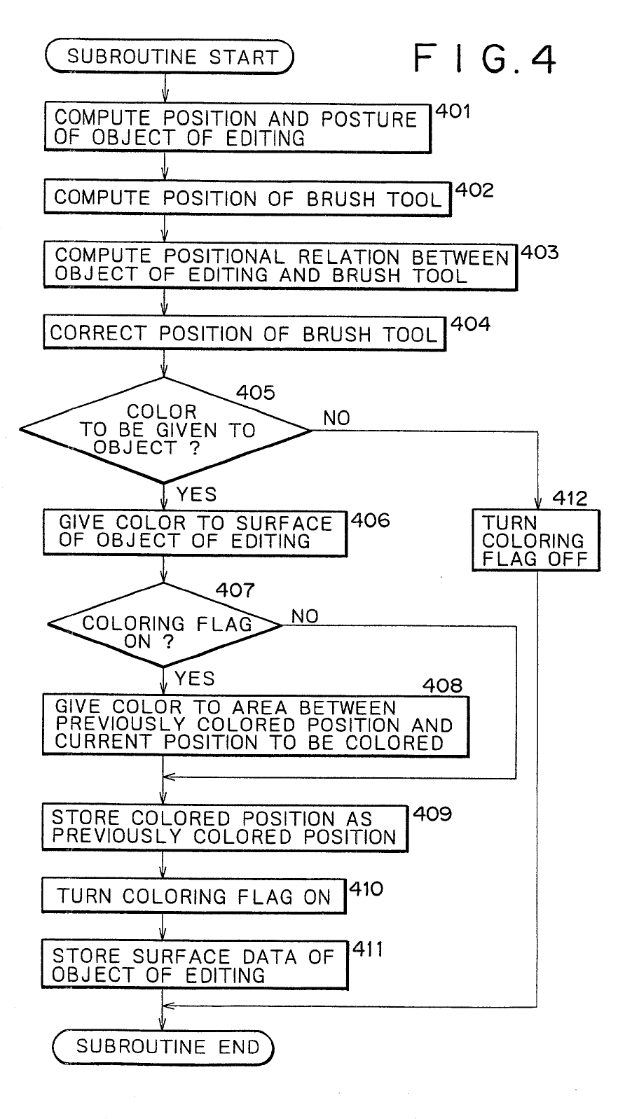

FIG. 4 is a flowchart representing a subroutine of using a brush tool for changing information on surfaces of an object of editing. Details of the processing are explained by referring to the flowchart as follows. As shown in the figure, the flowchart begins with a step 401 at which a position and a posture of the object of editing in the 3-dimensional space are computed from information acquired from the input unit 206 at the step 302 of the flowchart shown in FIG. 3. The computed position and the computed posture are stored in the data memory 203 or the external storage unit 207 in some cases.

At the next step 402, a position of the brush tool in the 3-dimensional space is computed also from information acquired from the input unit 206 at the step 302 of the flowchart shown in FIG. 3. The computed position is stored in the data memory 203 or the external storage unit 207 in some cases. In this example, the posture of a brush tool is not computed. That is to say, the 3-dimensional position and angle sensor 102 shown in FIG. 1 is a 3-dimensional-position sensor which can be set to generate information on a posture or generate no such information. In an operation to give a color to a surface of an object of editing by taking the orientation of the brush tool into consideration, however, information on the posture of the brush tool needs to be acquired from the 3-dimensional position and angle sensor 102 and stored as input data. Then, a posture of the brush tool in the 3-dimensional space is computed from the input data.

At the next step 403, a positional relation between the object of editing and the brush tool is computed from the information on the position as well as the posture of the object of editing, which is computed at the step 401, and the information on the position as well as the posture of the brush tool, which is computed at the step 402. Results of the computation are stored in the data memory 203 and the external storage unit 207 in some cases. At the next step 404, if necessary, the position of the brush tool is corrected from the results of the computation of the positional relation.

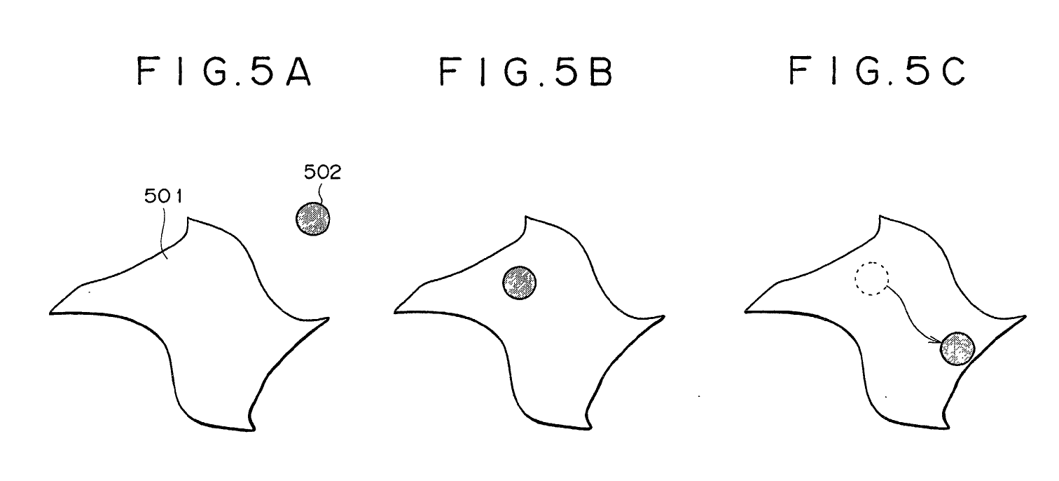

The processing carried out at the step 404 is an auxiliary operation carried out to make the operation to give a color to a surface of the object of editing easy to perform. Thus, the processing can also be omitted. An example of the processing carried out at the step 404 is control executed to forcibly move the brush tool to a position on the surface of the object of editing if the tool is located at a position separated away from the surface of the object. Another example is control executed to move the brush tool to crawl over the surface of the object of editing so that the tool does not enter the inside of the object. There are some applicable control methods for constraining the movement of an editing tool only on the surface of an object of editing as described above. One of the control methods is explained by referring to FIGS. 5A through 5C to 1OA and 10B.

The following description explains a control method whereby an operating point of an editing tool is capable of moving only over the surface of a 3-dimensional model. The operating point of an editing tool is a point at which processing using the editing tool is carried out. This control method includes the steps of: setting an intersection of a line connecting the present position of an editing tool to the position of the editing tool at the preceding execution and the surface of a 3-dimensional model serving as an object of editing as a surface point to be described later; and sequentially moving the surface point in accordance with a movement of the editing tool.

In the following description, a constrained-movement mode is used to imply a state in which the movement of an operating point is constrained on the surface of a 3-dimensional model. As described above, an operating point is defined as an execution point of processing based on an editing tool. On the other hand, a free-movement mode is used to imply a state in which the movement of an operating point is not constrained at all.

Control configurations in the constrained-movement mode and the free-movement mode are explained by referring to FIGS. 5A through 5C and subsequent figures. FIG. 5A is a diagram showing definitions of a 3-dimensional model 501 and an operating point 502. In an operation to specify a point on the surface of a 3-dimensional model 501 by using an operating point 502, the operating point 502 is made incapable of passing through the surface of the 3-dimensional model 501 and stopped on the surface at a position hit by the operating point 502. In this way, the movement of the position of the operating point is constrained on the surface of the 3-dimensional model 501 as shown in FIG. 5B. The side on which the 3-dimensional model 501 existed prior to the operation to stop the 3-dimensional model 501 on the surface of the 3-dimensional model 501 is referred to as a front side. The side opposite to the front side with respect to the surface of the 3-dimensional model 501 is referred to as a back side.

In a relation with the surface of the 3-dimensional model 501, the position of the operating point 502 in an unconstrained state is referred to as a reference point. A point on the surface of the 3-dimensional model 501 is controlled on the basis of a reference point. Such a controlled point on the surface of the 3-dimensional model 501 is referred to as a surface point for the reference point. Thereafter, the operating point moves continuously by sliding over the surface of the 3-dimensional model 501 as shown in FIG. 5C dependent on the movement of the reference point until a condition is satisfied. An example of a satisfied condition is the fact that the reference point is returned to the front side.

An algorithm adopted by the embodiment is explained in detail by referring to a flowchart and a model diagram.

Surface-Point Subroutine

A surface-point subroutine generates a surface point when a specific condition is satisfied. An example of a satisfied specific condition is an event in which the operating point 502 passes through the surface of the 3-dimensional model 501. The created surface point is taken as a tentative position of the operating point 502. Thus, the operating point 502 appears to have been stopped at the tentative position on the surface of the 3-dimensional model 501. The surface point is then updated by the surface-point subroutine in accordance with the movement of the reference point so that the surface point moves continuously over the surface of the 3-dimensional model 501.

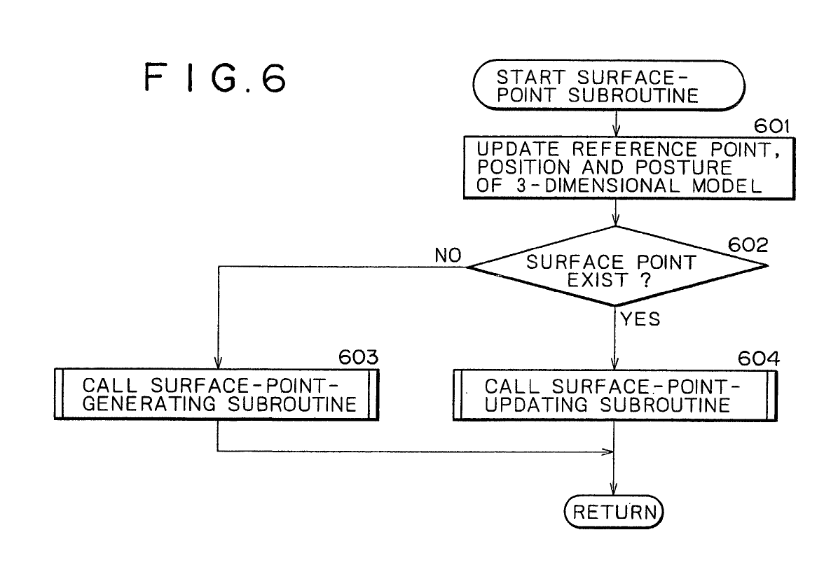

FIG. 6 shows a flowchart representing the surface-point subroutine for setting a surface point for an operating point by adoption of a method implemented by this embodiment. The surface-point subroutine is invoked by the 3-dimensional-model-processing system at time intervals or in the event of a hardware interrupt. With the surface-point subroutine not activated, the 3-dimensional-model-processing system may carry out processing other than the processing represented by the subroutine. In addition, the 3-dimensional-model-processing system is initialized before the surface-point subroutine is invoked for the first time.

An outline of the algorithm adopted in this embodiment is explained by referring to the flowchart shown in FIG. 6.

The 3-dimensional-model-processing system is initialized with a surface point for the reference point not existing before the surface-point subroutine is invoked for the first time. As shown in FIG. 6, the surface-point subroutine starts with a step 601 at which the position as well as the posture of a 3-dimensional model and the position of a reference point are updated. The operation to update the positions and the posture is based on input information received from the 3-dimensional positional and angle sensors 101 and 102 shown in FIG. 1.

The flow of the subroutine then goes on to a step 602 to form a judgment as to whether or not a surface point for the reference point exists. If a surface point does not exist, the flow of the subroutine goes on to a step 603 to call a surface-point-generating subroutine for determining whether a surface point is to be generated. If a condition for generation of a surface point is satisfied, the surface point is generated. If the outcome of the judgment formed at the step 602 indicates that a surface point for the reference point exists, on the other hand, the flow of the subroutine goes on to a step 604 to call a surface-point-updating subroutine for updating the position of the surface point. If necessary, the surface point is deleted.

The surface-point-generating subroutine called at the step 603 and the surface-point-updating subroutine called at the step 604 are explained in detail as follows.

Surface-Point-Generating Subroutine

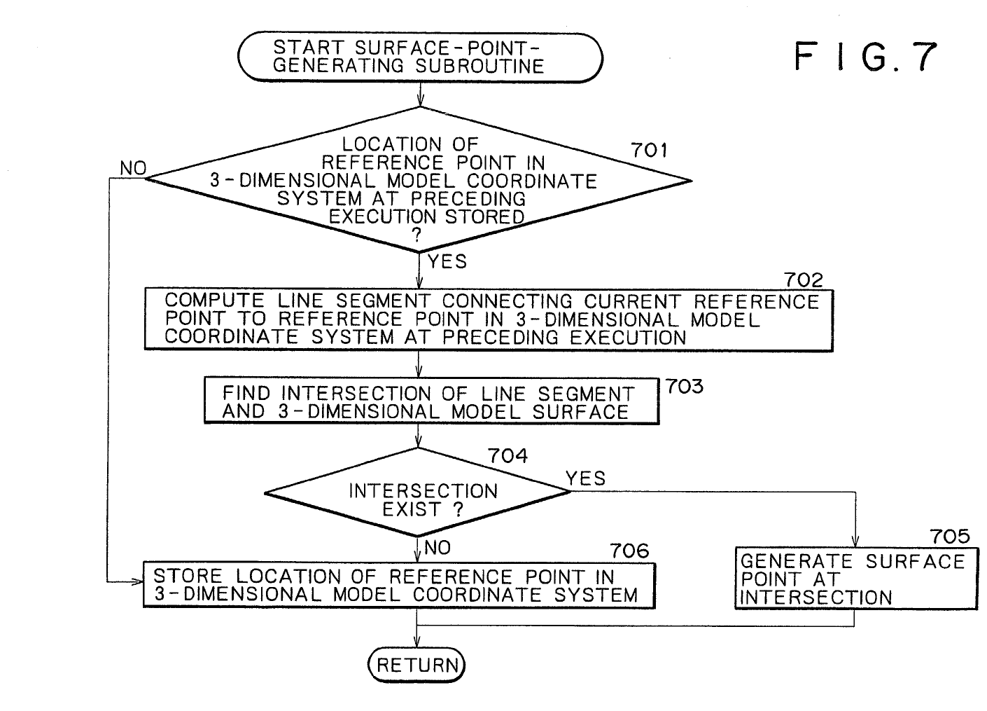

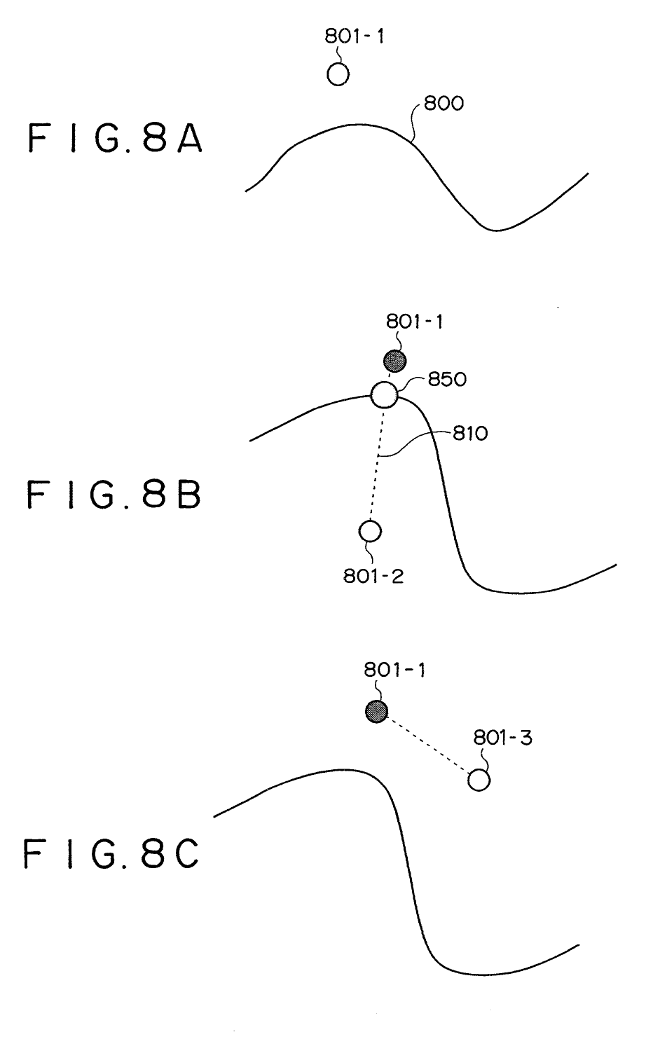

FIG. 7 shows a flowchart representing the surface-point-generating subroutine of this embodiment. FIGS. 8A through 8C are diagrams each showing a model used for explaining the surface-point-generating subroutine. The surface-point-generating subroutine is explained by referring to these figures as follows.

As shown in FIG. 7, the surface-point-generating subroutine begins with a step 701 to form a judgment as to whether or not information on the position of a reference point in a 3-dimensional coordinate system at the preceding execution is stored in a memory. The 3-dimensional coordinate system is a coordinate system established with the processed 3-dimensional model serving as a center. Normally, if this surface-point-generating subroutine is called for the first time, no such information is stored. If no such information is stored, the flow of the subroutine goes on to a step 706 at which the position of an operating point is stored as the position of a reference point. The subroutine is then ended.

Processing is further explained by referring to the model diagram shown in FIGS. 8A through 8C. At a certain point of time, a reference point 801-1 for a 3-dimensional model 800 exists at a position shown in FIG. 8A. As described earlier, the reference point 801 -1 is an operating point with no constraints. At the next execution, the operator operates a model-driving 3-dimensional sensor or a tool-driving 3-dimensional sensor to change the position and the posture of the 3-dimensional model 800, shown on the picture display unit, relative to the reference point as shown in FIG. 8B.

The reference point 801-1 moves relatively to the 3-dimensional model 800. The reference point 801-1 shown in FIG. 8B is a position of the reference point in the same 3-dimensional model coordinate system as that shown in FIG. 8A. On the other hand, a reference point 801-2 is a position of the reference point in the current 3-dimensional model coordinate system. In FIGS. 8A through 8C, a white circle denotes the current position of the reference point. On the other hand, a black circle is the position of the reference point at the preceding execution. With the reference point brought to the position shown in FIG. 8B, at a step 702 of the flowchart shown in FIG. 7, a line segment 810 is drawn to connect the reference point 801-1 or the position of the reference point in the 3-dimensional model coordinate system at the preceding execution and the reference point 801 -2 or the current position of the reference point in the 3-dimensional model coordinate system. At the next step 703, an intersection of the line segment 810 drawn at the step 702 and the surface of the 3-dimensional model 800 is found. The flow of the subroutine then goes on to a step 704 to form a judgment as to whether or not such an intersection exists. If such an intersection exists, the flow of the subroutine goes on to a step 705 at which a surface point 850 is newly generated at the intersection. That is to say, if the reference point passes through the surface of the 3-dimensional model 800, a surface point 850 is generated at a position passed through by the reference point.

It should be noted that, when the reference point has moved relatively to the 3-dimensional model 800 as shown in FIG. 8C, on the other hand, the outcome of the judgment formed at the step 704 will indicate that such an intersection does not exist. In this case, the flow of the subroutine goes on to a step 706 at which the current position of the reference point in the 3-dimensional model coordinate system, that is, the reference point 801-3 shown in FIG. 8C, is stored for the next step.

Surface-Point-Updating Subroutine

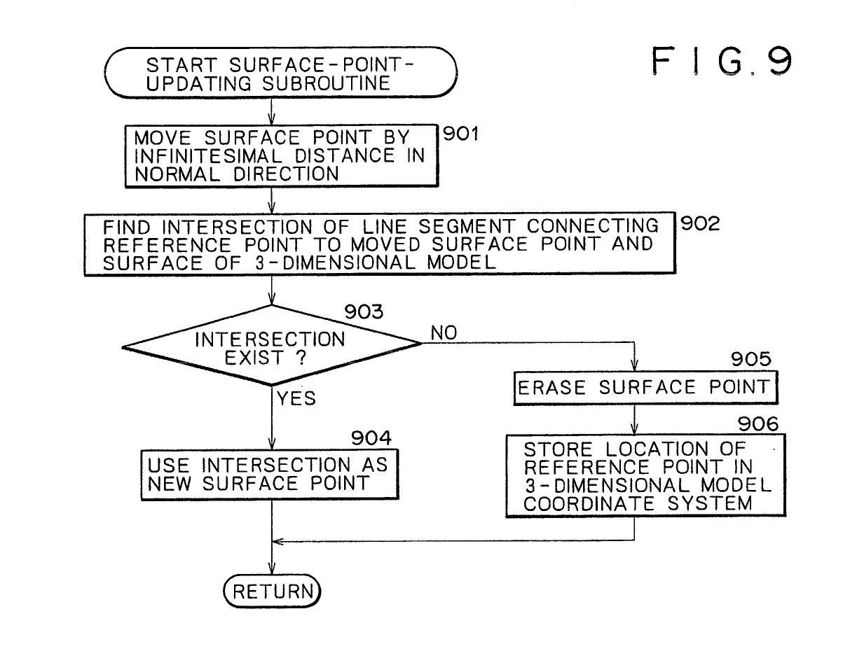

FIG. 9 is a flowchart representing the surface-point-updating subroutine of this embodiment. FIGS. 1 OA and 1 OB are diagrams each showing a model used for explaining the surface-point-updating subroutine. The surface-point-updating subroutine is explained by referring to these figures as follows.

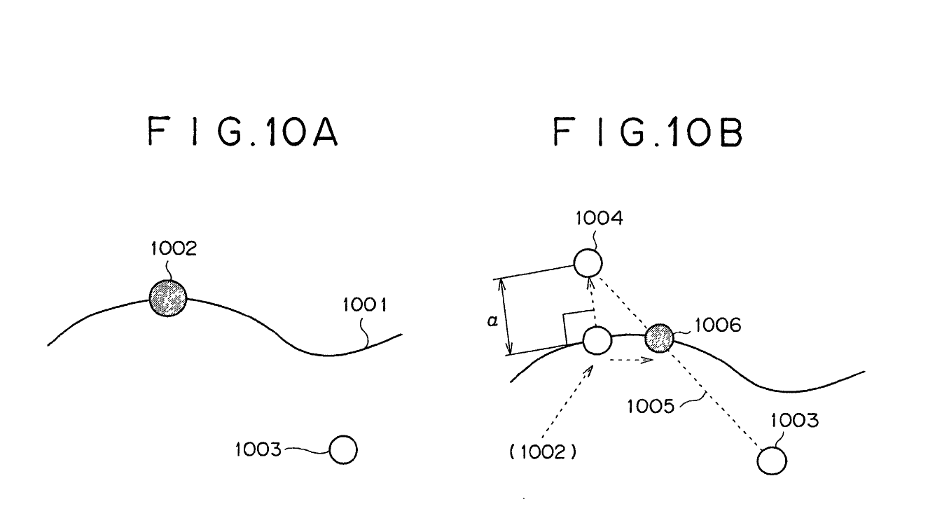

Assume a 3-dimensional model 1001 with a surface shown in FIGS. 10A and 10B. Let a surface point 1002 be set on the surface for an operating point. Also assume that a current reference point 1003 is set at the position of a tool. In this case, an algorithm to update a surface point 1002 for the operating point works as follows.

As shown in FIG. 9, the flowchart begins with a step 901 at which the surface point 1004 is moved in the direction normal to the surface of the 3-dimensional model 1001 by an appropriate distance α shown in FIGS. 10A and 10B. The distance α may be found from experiences or changed dynamically in accordance with the circumstance. Then, at the next step 902, a line segment 1005 is drawn to connect the current reference point 1003 to the surface point 1004 moved to the next location as shown in FIG. 10B, and an intersection of the line segment 1005 and the surface of the 3-dimensional model 1001 is found. The flow of the subroutine then goes to the next step 903 to form a judgment as to whether or not such an intersection exists. If such an intersection exists, the flow of the subroutine goes on to a step 904 at which the intersection is taken as a new surface point 1006. If the outcome of the judgment formed at the step 903 indicates that no intersection exists, on the other hand, the flow of the subroutine goes on to a step 905 at which the surface point is deleted. Then, at the next step 906, the position of the reference point in the 3-dimensional model coordinate system is stored for use in the surface-point-generating subroutine called at the next execution.

By carrying out the aforementioned processing to generate a surface point and the aforementioned processing to update a surface point for an operating point as described above, the operating point set on the surface of the 3-dimensional model slides over the surface of the 3-dimensional model, moving to another position on the surface in accordance with the movement of the editing tool. Assume that an operating point moving over the surface of such a 3-dimensional model is set as an operating point applicable to the editing tool. In this case, when the operator moves the editing tool to a position in close proximity to the 3-dimensional model, the operating point also moves, sliding over the surface of the 3-dimensional model. Thus, processing to change information on surfaces of the 3-dimensional model such as processing to draw characters in a specific area on the surface of the 3-dimensional model or to add a pattern to the area can be carried out with a high degree of accuracy.

It should be noted that the processing to constrain the movement of the operating point on a surface of an object of editing does not have to be carried out. Instead, the processing is performed only if necessary. The explanation of the subroutine of the brush tool is continued by referring back to the flowchart shown in FIG. 4.

The flow of the subroutine then goes on to a step 405 to form a judgment as to whether or not to give a color to the object of editing. The formation of the judgment is based on the positional relation corrected at the step 404. If the brush tool is positioned at a location in close proximity to the object of editing, the result of the judgment indicates that a color is to be given to the object of editing. The formation of a judgment as to whether or not the brush tool is positioned at a location in close proximity to the object of editing is based on a result of a judgment as to whether or not a distance between the tool and the object is shorter than a threshold value.

Note that it is possible to provide a control configuration wherein a combination of a plurality of criteria is taken as a condition for starting processing to give a color to an object of editing. For example, the processing to give a color to an object of editing is started only if the brush tool is positioned at a location in close proximity to a surface of the object of editing and a command making a request for the processing is received from the input unit 206. Typically, such a command is entered by pressing a command input button provided on the input unit 206.

If the outcome of the judgment formed at the step 405 indicates that a color is to be given to the object of editing, the flow of the subroutine goes on to a step 406. If a color is not to be given to the object of editing, on the other hand, the flow of the subroutine goes on to a step 412. At the step 406, a color is given to the surface of an object of editing on the basis of the positional relation between the object and the brush tool computed at the step 403 and position of the brush tool corrected at the step 404. The color is given to the object of editing in accordance with an attribute of the brush tool. If the object of editing is a polygon, for example, colors are typically given to a plurality of vertexes of the polygon receiving the colors. The polygon itself is then colored by interpolation of colors given to the vertexes. That is to say, attribute data set at each of the vertexes is changed to a color attribute set in the brush tool. In this way, processing according to an attribute set in the brush tool can be implemented on the object of editing. In addition, if the object of editing is an object, which a picture is mapped onto by giving a color to positions on the mapped picture corresponding to color positions, it is possible to carry out processing to give a color to the object being processed.

The flow of the subroutine then goes on to a step 407 at which a coloring flag stored in the data memory 203 or the external storage unit 207 in some cases is examined to form ajudgment as to whether the flag is ON or OFF. If the coloring flag is ON, the flow of the subroutine goes on to a step 408. If the coloring flag is OFF, on the other hand, the flow of the subroutine goes on to a step 409. The coloring flag is an indicator as to whether or not a coloring process has been carried out in the preceding loop. The coloring flag has 2 values, namely, ON and OFF. The ON value indicates that a coloring process has been carried out in the preceding loop while the OFF value indicates that no coloring process has been carried out in the preceding loop. At the steps 301 and 311 of the flowchart shown in FIG. 3 to initialize the surface-information-changing mode, the coloring flag is set at the OFF value.

At the step 408, a color is given to the object of editing by interpolation of a preceding coloring position and a position colored at the step 406. The preceding coloring position is a position colored with colored-position data stored in the data memory 203 or the external storage unit 207 in some cases in the preceding loop. When the processing of the step 408 is carried out, a color can be given to the object of editing by interpolation among pieces of positional data given discretely in loops. As a result, the surface of the object of editing can be colored continuously.

At the next step 409, the position given to a color at the step 406 is stored in the data memory 203 or the external storage unit 207 in some cases as previous colored-position data. At the next step 410, the coloring flag is turned ON. At the next step 411, surface data representing a color given to the object of editing is stored in the data memory 203 or the external storage unit 207 in some cases before the subroutine is ended.

If the outcome of the judgment formed at the step 405 indicates that no color is to be given, on the other hand, the flow of the subroutine goes on to a step 412 at which the coloring flag is turned OFF before the subroutine is ended.

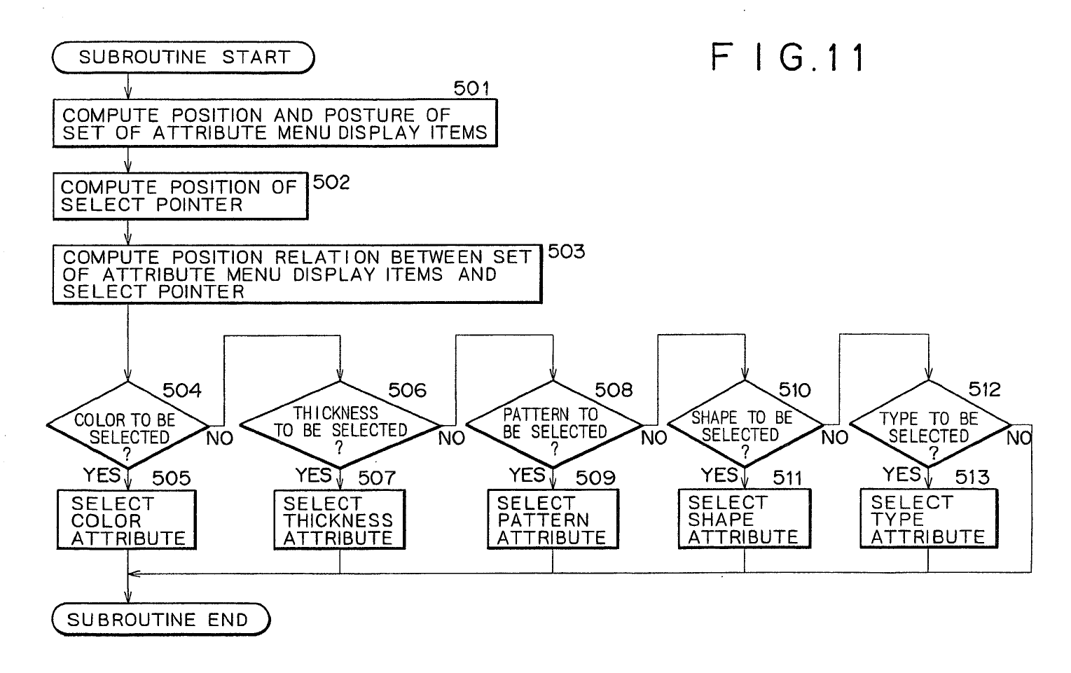

FIG. 11 is a flowchart representing a tool-attribute-selecting subroutine for selecting an attribute of a brush tool. As shown in the figure, the flowchart begins with a step 501 at which the position and the posture of a menu are computed on the basis of information input from the input unit 206 at the step 302 of the flowchart shown in FIG. 3, and stored in the data memory 203 or the external storage unit 207 in some cases. The menu is a set of attribute menu display items each representing an attribute of a tool. Information input at the step 302 is not only information on a position, but also information on a posture. Thus, it is possible to create a menu located 3-dimensionally. In order to display a menu expressed 2-demensionally, however, the information on a posture is not required.

By the same token, at the next step 502, the position of a select pointer is computed. The select pointer is used for selecting an attribute in the set of attribute menu display items. It is not always necessary to fix the positions of both the set of attribute menu display items and the select pointer. For example, only the position of the set of attribute menu display items is fixed while the select pointer can be moved to point to a desired attribute on the list.

At the next step 503, a positional relation between the set of attribute menu display items and the select pointer is computed. The flow of the subroutine then goes on to a step 504 to form a judgment as to whether or not a color attribute is to be selected. The formation of the judgment is based on the positional relation computed at the step 503. If a color attribute is to be selected, the flow of the subroutine goes on to a step 505 at which a color attribute of the brush tool pointed to by the select pointer is selected. Assume that the select pointer is positioned at the red color of the set of attribute menu display items. In this case, the red color is selected as a color attribute.

If the outcome of the judgment formed at the step 504 indicates that a color attribute is not to be selected, on the other hand, the flow of the subroutine goes on to a step 506 to form a judgment as to whether or not a thickness attribute is to be selected in the same way. If a thickness attribute is to be selected, the flow of the subroutine goes on to a step 507 at which a thickness attribute is selected.

By the same token, selection of a pattern attributes, such as a shading-off, a gradation, a pattern, and a texture, is determined at a step 508 and a desired pattern attribute is selected at a step 509. Likewise, selection of a shape attribute, such as an arrow, is determined and a step 510 and a desired shape attribute is selected at a step 511. Similarly, selection of a type attribute, such as a pencil, a pen or a crayon is determined at a step 512, and a desired type attribute is selected at a step 513.

Assume for example that a crayon is selected as a type attribute. In this case, the coloring process results in concentration unevenness as if a color were given by using a crayon. In addition, these attributes may be omitted in dependence of applications. On the contrary, the number of tool attributes can also be increased. If the outcome of the judgment formed at the step 512 indicates that the type attribute is not to be selected, on the other hand, the subroutine is ended by selecting none of the attributes of the brush tool.

In addition, in order to change an attribute of the brush tool, it is not always necessary to use the set of attribute menu display items and the select pointer. Instead, an attribute of the brush tool can be selected or changed on the basis of the input information acquired at the step 302 of the flowchart shown in FIG. 3. Assume for example that the input unit 206 has buttons for specifying colors, such as red, blue, and green, as color attributes as well as buttons for specifying patterns as a lattice, dots and stripes as pattern attributes. By pressing a button, an attribute of the brush tool associated with the button can be changed directly.

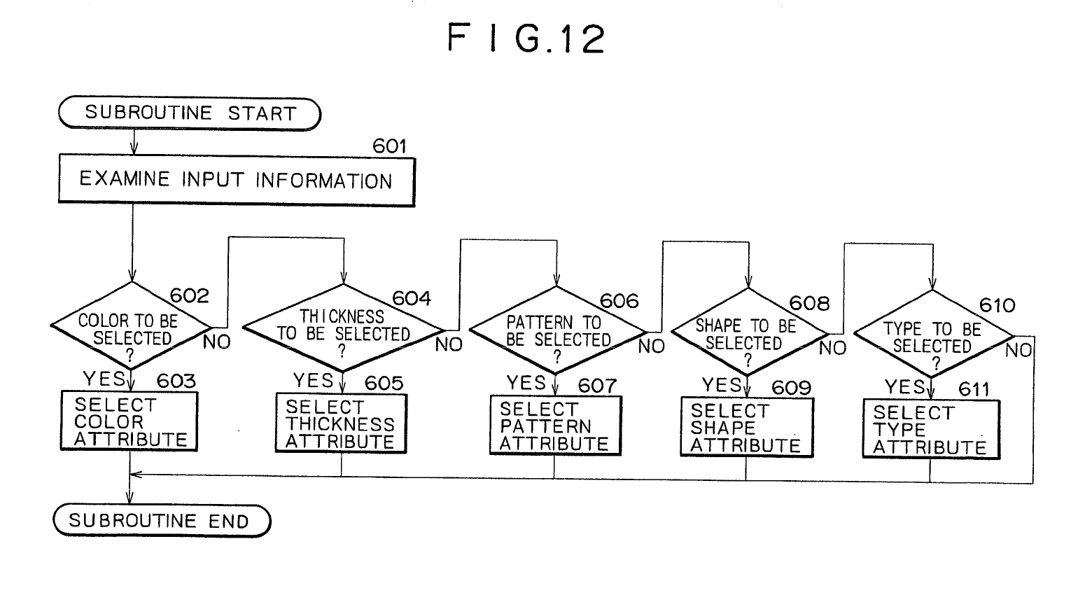

FIG. 12 is a flowchart representing this feature. The steps 501 to 503 of the flowchart shown in FIG. 11 correspond to a step 601 of the flowchart shown in FIG. 12. At the step 601, input information is examined to form a judgment as to whether or not a request for setting of a color attribute is received from the input unit 206. At other steps, the same processing as that of the flowchart shown in FIG. 11 is carried out.

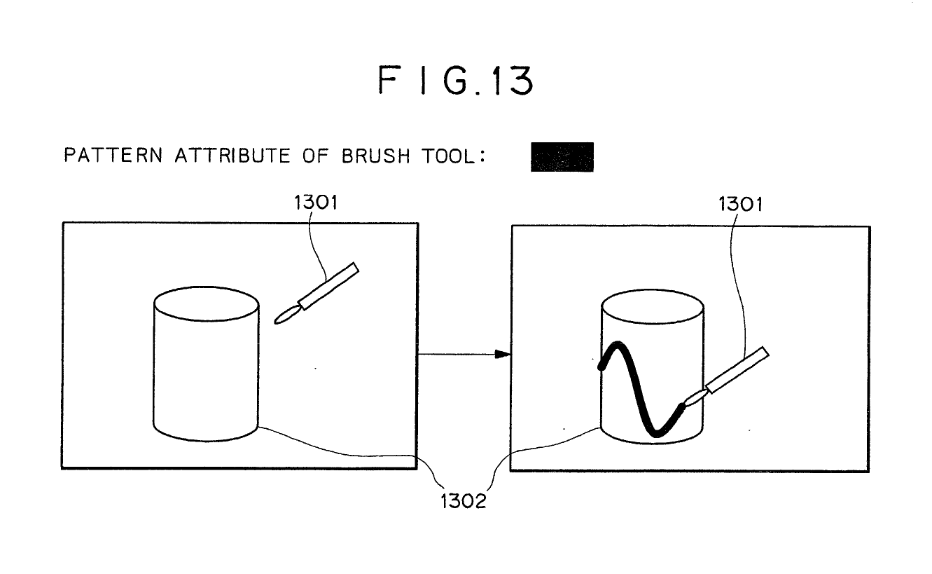

FIG. 13 is a diagram showing an implementation of processing to change information on surfaces of an object 1302 being edited by means of a brush tool 1301 shown in FIG. 13. From information on the position of the brush tool 1301 and information on the position as well as the posture of the object of editing 1302, a color can be given to a surface of the object of editing 1302. In addition, instead of giving a new color to the object of editing 1302 over the existing color, processing to mix the new color with the existing color can also be carried out.

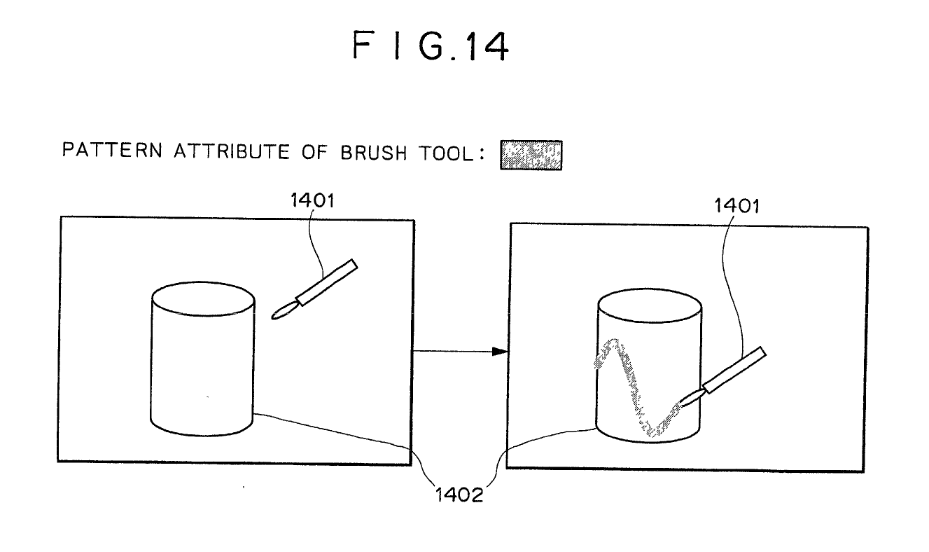

FIG. 14 is a diagram showing a case in which, from information on the position of a brush tool 1401 and information on the position as well as the posture of an object 1402 being edited, a color is given to a surface of the object of editing 1402 with a dot pattern selected as a pattern attribute of the brush tool 1401. In the example shown in the figure, the dot pattern is shown in a gray color. By changing an attribute of the brush tool 1401 in this way, a way to give a color to the 1402 can be determined.

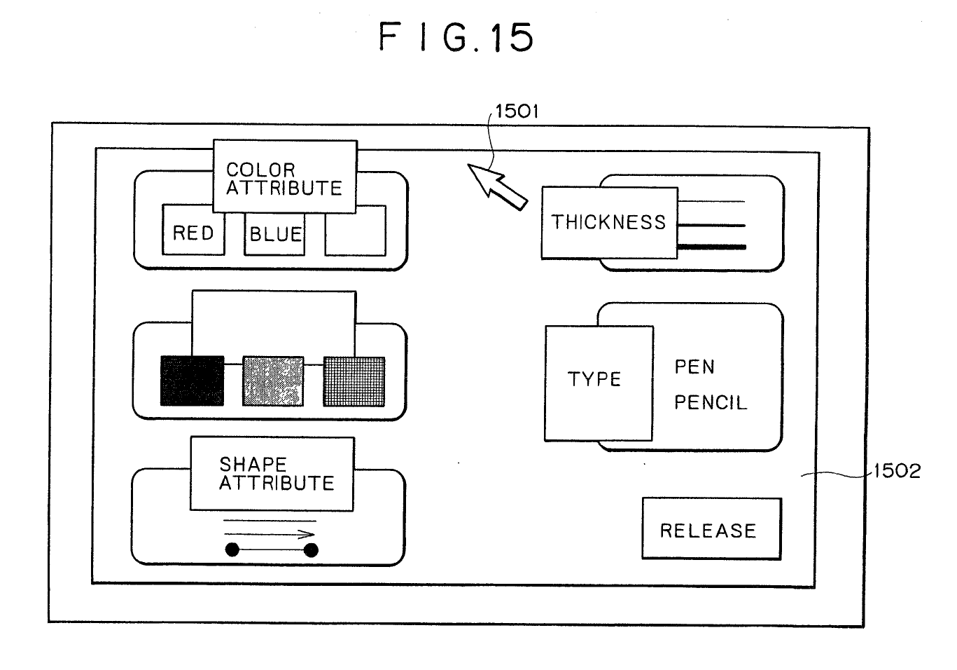

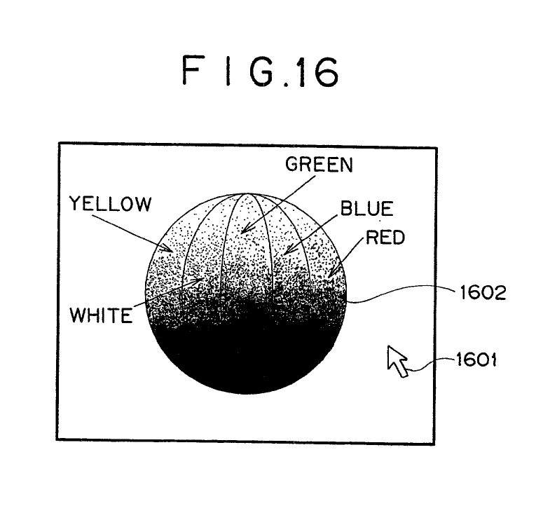

FIG. 15 is a diagram showing a typical user interface for carrying out processing to select an attribute of a brush tool. As shown in FIG. 15, a select pointer 1501 is used for selecting an attribute shown in a set of attribute menu display items 1502 in order to change an attribute of a brush tool. In the typical user interface shown in FIG. 15, all attributes are displayed at the same time. Note, however, that it is also possible to provide a configuration wherein a window is created for each attribute category and displayed in a hierarchical manner for each window. In addition, while the set of attribute menu display items 1502 is displayed as a set of panels in this example, the list can also be shown as a set of 3-dimensional bodies such as cubes or spheres. By selecting one of the 3-dimensional bodies, it is possible to display attributes such as a color attribute and a pattern attribute on each surface of the object of editing.

FIG. 16 is a diagram showing a color-attribute menu 1602 of color attributes as a 3-dimensional body having a spherical shape with the color attributes laid out on the surface of the sphere. While the color-attribute menu 1602 is displayed in black and white colors only, the menu includes color attributes arranged sequentially, starting with a yellow color at the leftmost end, followed by a white color, a green color, and a blue color and ending with a red color at the rightmost end. The upper portion represents bright colors while the lower one represents dark colors. The user specifies an item on the color-attribute menu 1602 by using a select pointer 1601 to select a desired color. Information on the position and the posture of the color-attribute menu 1602 can be changed by operating the 3-dimensional position and angle sensor 101 shown in FIG. 1. On the other hand, information on the position and the posture of the select pointer 1601 can be changed by operating the 3-dimensional position and angle sensor 102 also shown in FIG. 1. Thus, by operating 2 sensors, namely, the 3-dimensional position and angle sensor 101 and the 3-dimensional position and angle sensor 102, the operator is capable of selecting a color displayed on a 3-dimensional object, that is, the color-attribute menu 1602, with a high degree of freedom. By providing various degrees of brightness to each of the color attributes laid out on the surface of the 3-dimensional object as described above, a greater number of selections (or colors) can be presented in a compact format.

As described above, in accordance with the 3-dimensional-model-processing apparatus and 3-dimensional-model-processing method of the present invention, processing is carried out on an object of editing in accordance with a variety of attributes of an editing tool. In the case of a brush tool, for example, the attributes include color, thickness, pattern, shape, and type attributes. That is to say, first of all, in an attribute-changing mode, attributes of an editing tool, which are selected by the operator by using a menu of attributes shown in FIG. 15 or 16, are stored in the data memory 203 or the external storage unit 207 in some cases.

Then, in a surface-information-changing mode, processing is carried out to change object attribute data representing information on surfaces of an object of editing in accordance with the attributes of the brush tool, which were stored in the data memory 203. The processing circuit 201 of FIG. 2 serving as a control means carries out processing to change information on surfaces of an object of editing on the basis of attribute data of the brush tool. Such information and the attribute data are stored in the data memory 203. If the object of editing is a polygon, the information is data associated with vertexes of the polygon.

The object of editing having the modified information on surfaces thereof, that is, the 3-dimensional model, is subjected to rendering based on the information on the surfaces or the attributes of the object. Its picture information is stored in the frame memory 204 to be eventually output to the picture display unit 205.

As described above, in the 3-dimensional-model-processing apparatus provided by the present invention, a variety of attributes can be set in an editing tool, and processing based on the set attributes can be carried out on an object of editing, that is, a 3-dimensional model, to reflect the attributes set in the object of editing.

Spray Tools

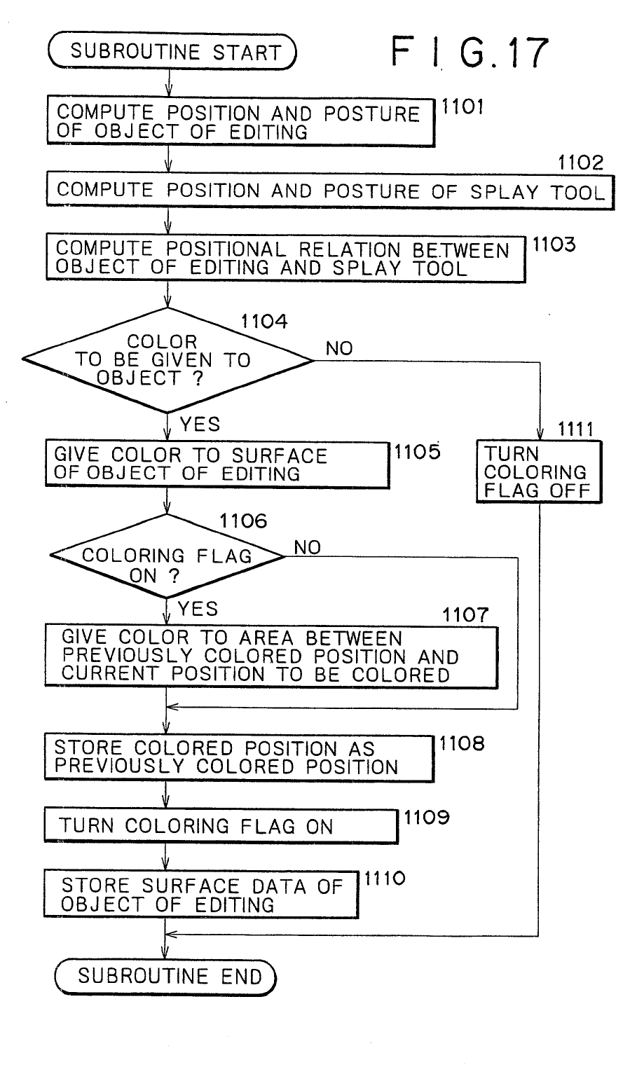

Next, processing for a spray tool used as an editing tool is explained. FIG. 17 is a flowchart representing a subroutine of using a spray tool for changing information on surfaces of an object of editing. Details of the processing are explained by referring to the flowchart as follows. The processing is basically identical with the processing for changing information on surfaces of an object of editing by using a brush tool as shown in FIG. 4 except that, at a step 1102, a posture of the spray tool is also computed.

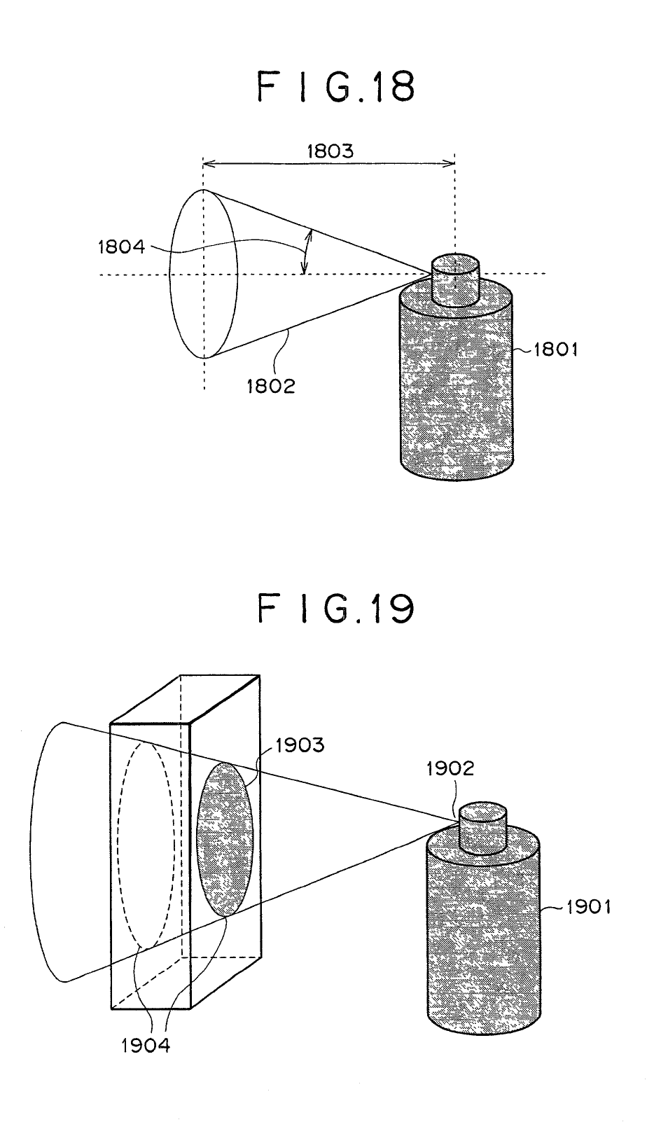

FIG. 18 is a diagram showing the configuration of an embodiment implementing a spray tool. As shown in FIG. 18, a spray tool 1801 has an operating area 1802. An object of editing existing in the operating area 1802 can be colored. The operating area 1802 is a conical area expressed by parameters representing by a distance 1803 and an angle 1804. By changing these parameters, the operating area 1802 of the spray tool can be varied. In order to make an intersection of the spray tool 1801 and the object of editing readily visible, it is desirable to make the display of the operating area 1802 semi transparent.

Since a spray tool has an operating area as described above, information on the posture of the spray tool needs to be computed in addition to the information on the position thereof.

If information on the posture of the spray tool is not computed at a step 1102, that is, if the posture of the spray tool is fixed, it is necessary to change the position and the posture of the object of editing in order to move the surface of the object of editing to be colored to the inside of the operating area of the spray tool.

At the next step 1103, an area to be colored is computed from a positional relation between the object of editing and the spray tool. The area to be colored is a surface of the object of editing. This surface exists in the operating area of the spray tool. An example of the area to be colored is shown in FIG. 19. As shown in FIG. 19, there is a plurality of candidates 1904 for an area 1903 to be colored in the operating area of a spray tool 1901. If the candidates 1904 for an area 1903 to be colored exist on the same line originating from a spray start point 1902 which is determined by the position of the spray tool 1901, a candidate closest to the spray start point 1902 is taken as an area 1903 to be colored.

In this case of the spray tool, the flowchart shown in FIG. 17 does not include processing carried out at the step 404 of the flowchart shown in FIG. 4 to correct the position of the brush tool. This is because the formation of a judgment as to whether to give a color to an object of editing by using a spray color is based on the operating area and the area to be colored. That is to say, unlike a brush tool, it is not always necessary to position the spray tool or an operation point thereof on the surface of the object of editing.

The flow of the subroutine then goes on to a step 1104 to form a judgment as to whether or not an area to be colored exists and a command to give a color to such an area has been received. If an area to be colored exists and a command to give a color to such an area has been received, the flow of the subroutine goes on to a step 1105. If an area to be colored does not exist and/or a command to give a color to such an area has not been received, on the other hand, the flow of the subroutine goes on to a step 1111. Pieces of processing carried out at the step 1105 and subsequent steps are identical with the processing to change information on surfaces of an object of editing by using a brush tool.

An attribute-selecting subroutine for a spray tool is executed in the same way as the attribute-selecting subroutine shown in FIGS. 11 and 12 for a brush tool. A spray tool can be provided with a variety of attributes other than attributes of the brush tool, such as the color and pattern attributes. For example, a spray tool can be provided with a distance 1803 and an angle 1804, which are shown in FIG. 18, as attributes.

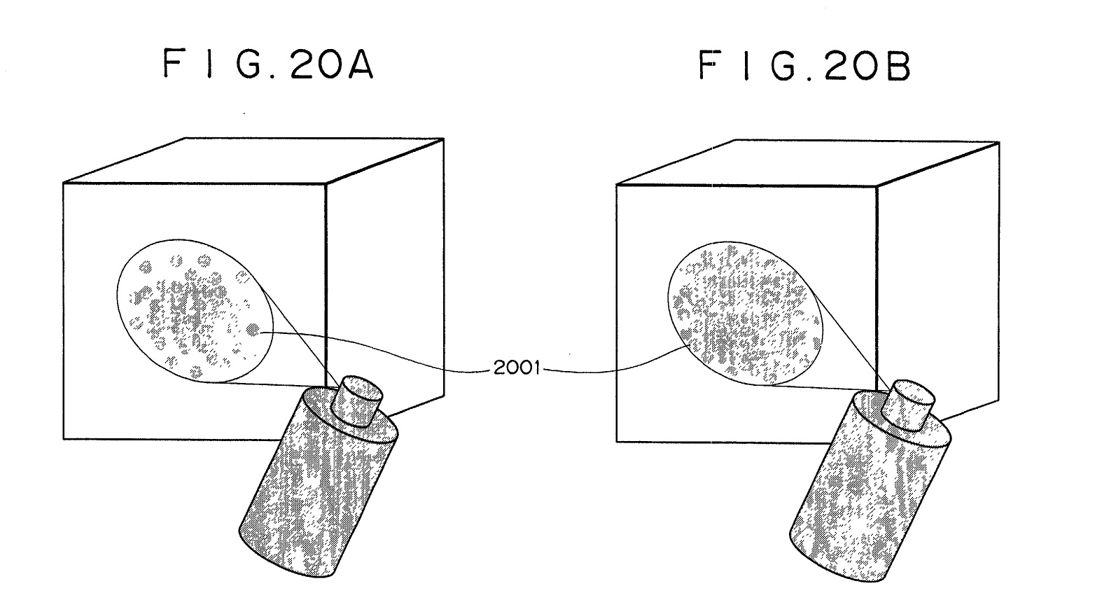

In addition, for example, a spray tool can have a particle generation rate as an attribute. The higher the particle generation rate, the higher the density at which a color is given. On the contrary, the lower the particle generation rate, the less the clusters of the color. FIGS. 20A and 20B are diagrams showing the states. FIG. 20A is a diagram showing typical processing of a spray tool with set attributes including a low particle generation rate. On the other hand, FIG. 20B is a diagram showing typical processing of a spray tool with set attributes including a high particle generation rate. An attribute is set to change the particle generation rate as follows. In one trial, a button of the 3-dimensional position and angle sensor 102 like the one shown in FIG. 1 is pressed once to give a color to a surface of an object of editing at an adjusted density. Depending on the application, however, a color can also be given uniformly to the entire area serving as a coloring object in a trial. In addition, it is desirable to randomly lay out positions of particles used for rendering the inside of an area 2001 to be colored. For example, particles at positions in close proximity to the center of an area to be colored are generated at a high rate and, the farther the position from the center, the lower the rate of generation of particles for the position. In this way, position-dependent non-uniformity of particles can be created to give a color to a surface of an object of editing as if the color were shaded off.

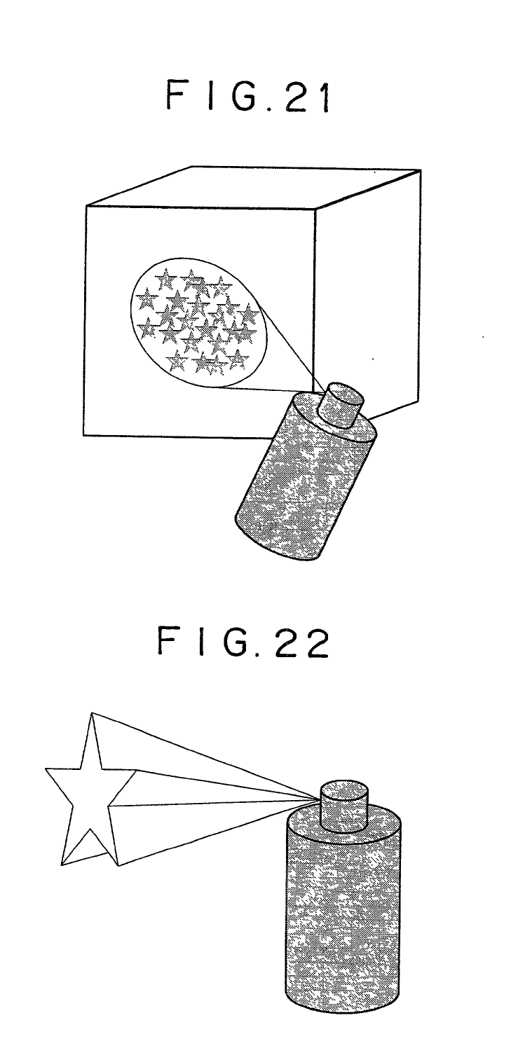

In addition to the particle generation rate, the particle size and the particle shape can each be used as an attribute. FIG. 21 is a diagram showing a case in which a star shape is taken as the particle shape. Furthermore, the particle shape and the particle size can be taken at random.

Moreover, the shape of the operating area of a spray tool does not have to be conical. The shape of the operating area of a spray tool can be determined arbitrarily instead. For example, the operating area of a spray tool can have a shape with a star cross section shown in FIG. 22. In this way, on an object of editing, colored areas can be created with a variety of shapes.

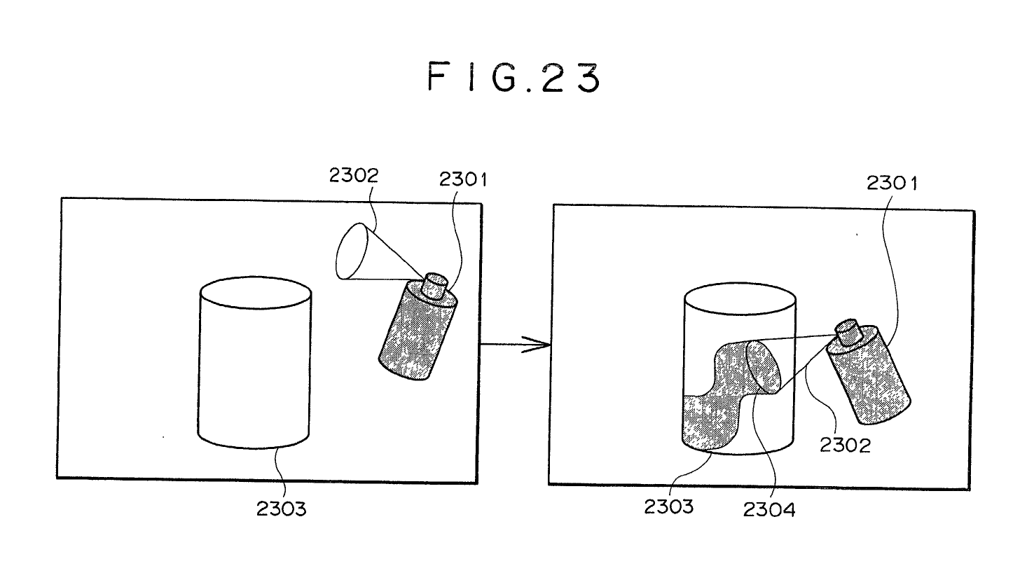

FIG. 23 is a diagram showing processing to change information on surfaces of an object of editing 2303 by using a spray tool 2301. As shown in FIG. 23, an area 2304 to be colored is determined by relations in position and posture between an operating area 2302 of the spray tool 2301 and the object of editing 2303. Thus, a color can be given to a surface of the object of editing 2303. It should be noted that, in the example shown in FIG. 23, an attribute of the spray tool 2301 is set to give a gray color to the area 2304 uniformly without regard to the particle size, the particle shape and the particle generation rate.

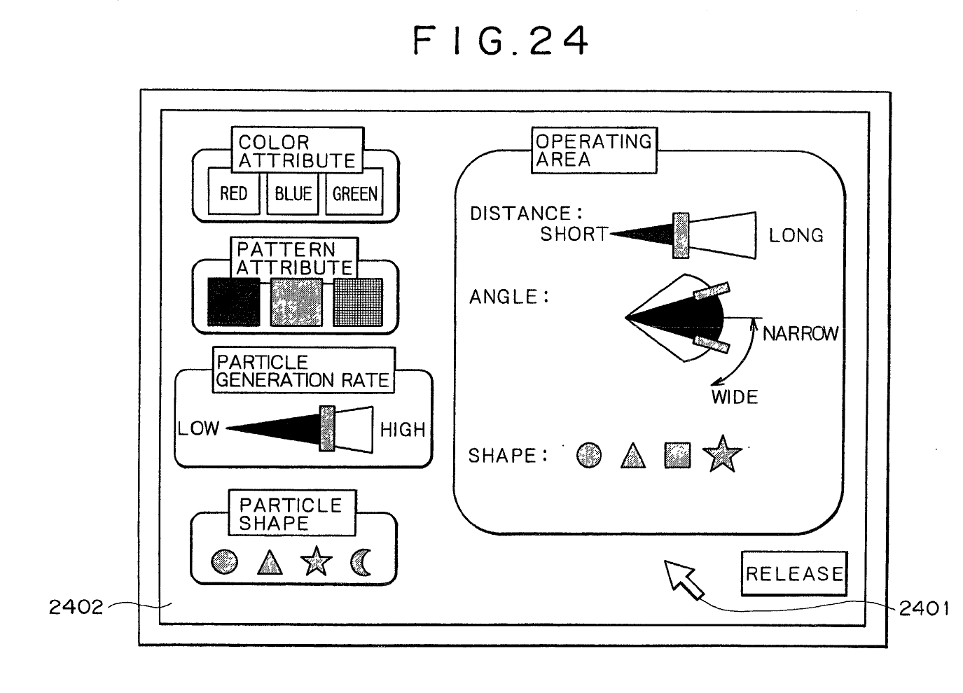

FIG. 24 is a diagram showing a configuration of an interface for carrying out processing to select an attribute of a spray tool. As shown in FIG. 24, an attribute is selected from a set of attribute menu display items 2402 by using a select pointer 2401 to change an attribute of the spray tool. In the interface configuration shown in FIG. 24, attributes of the spray tool are categorized into a color attribute, a pattern attribute, a particle-generation-rate attribute, and a particle-shape attribute. On the other hand, attributes of the operating area are classified into a distance attribute, an angle attribute, and a shape attribute. In the typical user interface shown in FIG. 24, all attributes are displayed at the same time. It should be noted that, however, it is also possible to provide a configuration wherein a window is created for each attribute category and displayed in a hierarchical manner for each window. In addition, while the set of attribute menu display items 2402 is displayed as a set of panels in this example, the list can also be shown as a set of 3-dimensional bodies, such as cubes or spheres, and attributes, such as a color attribute and a pattern attribute on each surface of the object of editing can be displayed.

As described above, in accordance with the 3-dimensional-model-processing apparatus and 3-dimensional-model-processing method of the present invention, processing is carried out on an object of editing in accordance with a variety of attributes of a spray tool used as an editing tool. The attributes include a color, a pattern, a particle generation rate, a particle shape, an operating-area distance, an operating-area angle, and a shape. That is to say, first of all, in an attribute-changing mode, attributes of the spray tool, which are selected by the operator by using a menu of attributes shown in FIG. 24, are stored in the data memory 203 or the external storage unit 207 in some cases.

Then, in a surface-information-changing mode, processing is carried out to change information on surfaces of an object of editing in accordance with the attributes of the spray tool, which were stored in the data memory 203. The processing circuit 201 of FIG. 2 serving as a control means carries out processing to change information on surfaces of an object of editing on the basis of attribute data of the spray tool. Such information and the attribute data are stored in the data memory 203. If the object of editing is a polygon, the information is data associated with vertexes of the polygon.

The object of editing having the modified information on surfaces thereof, that is, the 3-dimensional model, is subjected to rendering based on the information on the surfaces or the attributes of the object. Its picture information is stored in the frame memory 204 to be eventually output to the picture display unit 205.

Pasting Tool

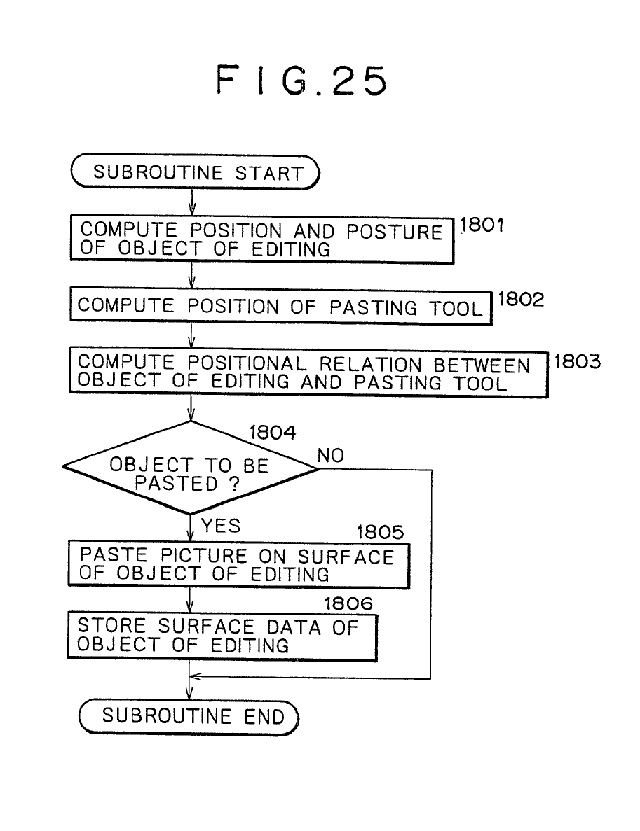

Next, processing for a pasting tool used as an editing tool is explained. FIG. 25 is a flowchart representing a subroutine of using a pasting tool for changing information on surfaces of an object of editing. Details of the processing are explained by referring to the flowchart as follows. The processing is basically identical with the processing for changing information on surfaces of an object of editing by using a brush tool as shown in FIG. 4. To be more specific, the processing carried out at a step 1801 to compute a position and a posture of the object of editing, the processing carried out at a step 1802 to compute a position of the pasting tool, and processing carried out at a step 1803 to compute a positional relation between the object of editing and the pasting tool are identical with their counterparts of the steps 401, 402 and 403 of the flowchart shown in FIG. 4 respectively. The flow of the subroutine then goes on to a step 1804 to form a judgment as to whether or not a picture is to be pasted. The formation of the judgment is based on the positional relation between the object of editing and the pasting tool, which is a relation computed at the step 1803. If a picture is to be pasted, the flow of the subroutine goes on to a step 1805. If a picture is not to be pasted, on the other hand, the subroutine is ended.

At the next step 1805, a 2-demensional picture prepared in advance is pasted on a surface of the object of editing. The pasting operation is based on the positional relation computed at the step 1803. In this case, it is desirable to paste the 2-dimensional picture on the object of editing in accordance with the shape of the object. In some cases, however, information on the 2-demensional picture is projected in parallel on the object of editing, or information on the surface of the object may also be changed. In addition, instead of merely drawing the 2-demensional picture over the object of editing, the 2-demensional picture may also be blended with information on the surface of the object.

The 2-demensional picture to be pasted is conceivable as an attribute of the pasting tool. That is to say, the attribute-selecting subroutine of the pasting tool can be used for editing the 2-demensional picture to be pasted in a 2-demensional system. By using the attribute-selecting subroutine in conjunction with a 2-demensional system, information modified by the 2-demensional system can be reflected in a picture pasted on an object of editing.

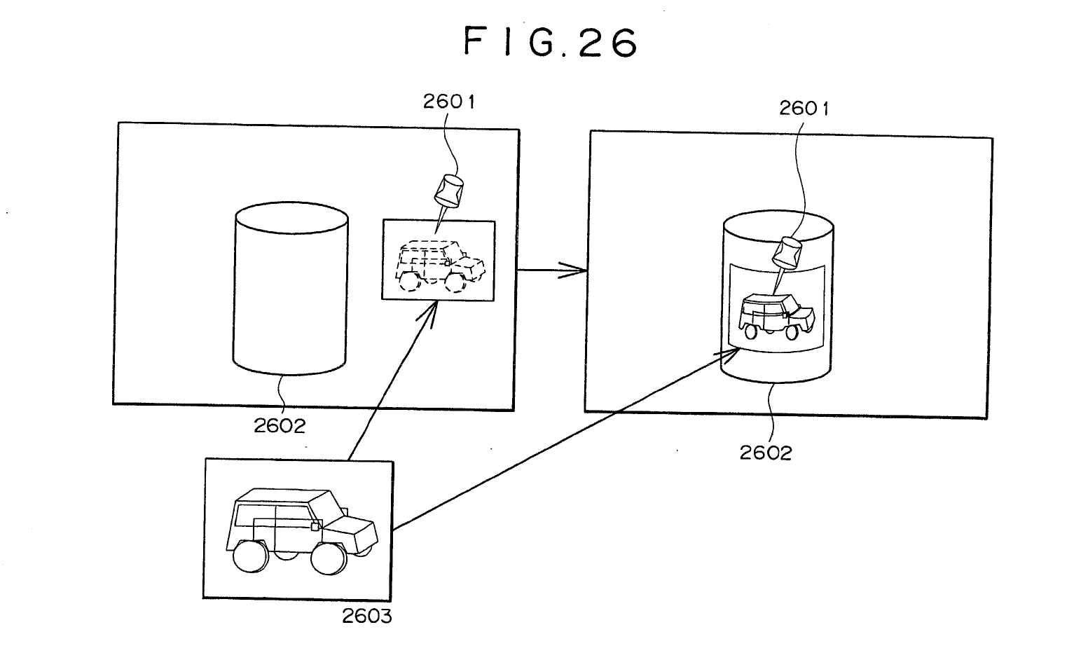

FIG. 26 is a diagram showing an embodiment implementing processing to change information on surfaces of an object of editing by using a pasting tool. As shown in FIG. 26, a 2-demensional picture 2603 prepared in advance can be pasted on a surface of an object of editing 2602. The surface is specified by using a pasting tool 2601. Also shown in the figure, picture data pasted on the surface of the object of editing 2602 by using the pasting tool 2601 is stuck 3 dimensionally, being adjusted to the shape of the surface of the object of editing 2602.

Such processing is carried out by the processing circuit 201 serving as control means as shown in FIG. 2 as a process for changing information on a surface of a 3-dimensional model. The process for changing information on surfaces of a 3-dimensional model is based on picture data which is the attribute data of the pasting tool stored in the data memory 203. An example of the information on surfaces is attribute data associated with vertexes of a polygon, which is an implementation of the 3-dimensional model representing the object of editing stored in the data memory 203.

It should be noted that processing can be carried out to give a color to an object of editing pasted with a picture by using a brush tool or a spray tool described earlier.

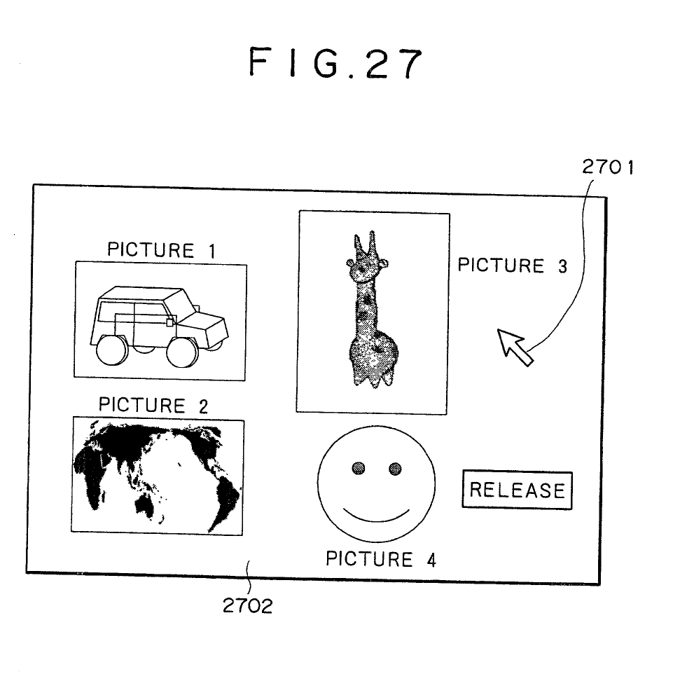

FIG. 27 is a diagram showing a configuration of an interface for carrying out processing to select an attribute of a pasting tool. As shown in FIG. 27, an attribute in a set of attribute menu display items 2702 is selected by using a select pointer 2701 in order to change an attribute of the pasting tool. The interface shown in FIG. 27 has a configuration wherein any one of a plurality of pictures to be pasted can be selected as an attribute of the pasting tool. In the typical user interface shown in FIG. 27, all attributes are displayed at the same time. Note, however, that it is also possible to provide a configuration wherein a window is created for each attribute category or each picture and displayed in a hierarchical manner for each window. In addition, while the set of attribute menu display items 2702 is displayed as a set of panels in this example of FIG. 27, the list can also be shown as a set of 3-dimensional bodies such as cubes or spheres. In this case, data of picture to be pasted is displayed on each surface of the 3-dimensional body.

As described above, in accordance with the 3-dimensional-model-processing apparatus and 3-dimensional-model-processing method of the present invention, processing is carried out on an object of editing in accordance with a variety of attributes of a pasting tool used as an editing tool. An attribute of the pasting tool is picture data selected as an object to be pasted. That is to say, first of all, in an attribute-changing mode, picture data selected by the operator by using a menu of attributes shown in FIG. 27 as an attribute of the pasting tool is stored in the data memory 203 or the external storage unit 207 in some cases.

Then, in a surface-information-changing mode, processing is carried out to change information on surfaces of an object of editing in accordance with the attribute of the pasting tool stored in the data memory 203. The processing circuit 201 of FIG. 2 serving as control means carries out processing to change information on surfaces of a 3-dimensional model serving as an object of editing on the basis of attribute data of the pasting tool, that is, the picture data. Such information and the attribute data are stored in the data memory 203. The object of editing having the modified information on surfaces thereof, that is, the 3-dimensional model, is subjected to rendering based on the information on the surfaces or the attributes of the object. Its picture information is stored in the frame memory 204 to be eventually output to the picture display unit 205.

Although the present invention has been described with reference to specific embodiments, those of skill in the art will recognize that changes may be made thereto without departing from the spirit and scope of the invention as set forth in the hereafter appended claims.

What is claimed is:

1. A 3-dimensional-model-processing apparatus for carrying out processing to change information on surfaces of a 3-dimensional model serving as an object of editing appearing on a picture display unit on the basis of information on 3-dimensional positions which is obtained from a 3-dimensional sensor comprising:
a controller executing control of processing carried out on said 3-dimensional model serving as an object of editing by using an editing tool appearing on said picture display unit, wherein:
said controller allows attributes of said editing tool to be changed and carries out processing to change said information on surfaces of said 3-dimensional model serving as an object of editing in accordance with said changed attributes of said editing tool.

2. A 3-dimensional-model-processing apparatus according to claim 1, wherein said controller executes control to store said changed attribute data of said editing tool in a memory, change object attribute data representing said information on surfaces of said object of editing in accordance with said attribute data of said editing tool stored in said memory and execute a rendering operation to display said 3-dimensional model serving as said object of editing on the basis of said changed object attribute data on said picture display device.

3. A 3-dimensional-model-processing apparatus according to claim 1, wherein said controller controls processing in at least two modes comprising an attribute-changing mode for changing attributes of said editing tool and a surface-information-changing mode for changing said information on surfaces of said 3-dimensional model serving as an object of editing;
in said attribute-changing mode,
a menu for setting attributes of said editing tool is displayed on said picture display unit and processing is carried out to store attribute-setting data entered via input means in a memory; and
in surfaces-information-changing mode,
said 3-dimensional model serving as an edited mode is displayed on said picture display unit, object attribute data representing said information on surfaces of said 3-dimensional model serving as an object of editing is changed in accordance with said attribute-setting data stored in said memory to represent attributes of said editing tool and a rendering operation based on said changed object attribute data is carried out to display said 3-dimensional model serving as an object of editing on said picture display unit.

4. A 3-dimensional-model-processing apparatus according to claim 1, wherein said controller executes control for making a processing operation point of said editing tool movable and constrained at positions on surfaces of said 3-dimensional model serving as an object of editing being processed.

5. A 3-dimensional-model-processing apparatus according to claim 1, wherein said editing tool is a brush tool for changing said information on surfaces of said 3-dimensional model serving as an object of editing and,
said editing tool is capable of setting at least one of its attributes, comprising a color, a pattern, a shape, a thickness and a type, at different values.

6. A 3-dimensional-model-processing apparatus according to claim 1, wherein said editing tool is a spray tool for changing said information on surfaces of said 3-dimensional model serving as an object of editing and
said editing tool is capable of setting at least one of its attributes, comprising a color, a pattern, a particle generation rate, a particle shape and a distance, angle and shape of an operating area, at different values.

7. A 3-dimensional-model-processing apparatus according to claim 1, wherein said editing tool is a pasting tool for changing said information on surfaces of said 3-dimensional model serving as an object of editing and
said editing tool is capable of setting data of a picture to be pasted as its attribute, at different values.

8. A 3-dimensional-model-processing method for carrying out processing to change information on surfaces of a 3-dimensional model serving as an object of editing appearing on picture display unit on the basis of information on 3-dimensional positions which is obtained from a 3-dimensional sensor, by using an editing tool appearing on said picture display unit,
said 3-dimensional-model-processing method comprising the steps of:
changing attributes of said editing tool; and
carrying out processing to change said information on surfaces of said 3-dimensional model serving as an object of editing in accordance with said changed attributes of said editing tool.

9. A 3-dimensional-model-processing method according to claim 8, wherein said step of changing attributes of said editing tool comprises the step of storing said changed attribute data of said editing tool in a memory; and
said step of carrying out processing to change said information on surfaces of said 3-dimensional model, changes object attribute data representing said information on surfaces of said object of editing in accordance with said attribute data of said editing tool stored in said memory, and carries out a rendering operation to display said 3-dimensional model serving as said object of editing on the basis of said changed object attribute data on said picture display unit.

10. A 3-dimensional-model-processing method according to claim 8 wherein:
at said step of changing attributes of said editing tool said attribute, a menu for setting attributes of said editing tool is displayed on said picture display unit and processing is carried out to store attribute-setting data entered via an input in a memory; and
at said step of carrying out processing to change said information on surfaces of said 3-dimensional model, said 3-dimensional model serving as an edited mode is displayed on said picture display unit, object attribute data representing said information on surfaces of said 3-dimensional model serving as an object of editing is changed in accordance with said attribute-setting data stored in said memory to represent attributes of said editing tool and a rendering operation based on said changed object attribute data is carried out to display said 3-dimensional model serving as an object of editing on said picture display unit.

11. A 3-dimensional-model-processing method according to claim 8, wherein control is executed for making a processing operation point of said editing tool movable and constrained at positions on surfaces of said 3-dimensional model serving as an object of editing.

12. A program-providing medium, comprising:
a medium having a computer program to be executed by a computer system for carrying out processing to change information on surfaces of a 3-dimensional model serving as an object of editing appearing on a picture display unit on the basis of information on 3-dimensional positions which is obtained from a 3-dimensional sensor, by using an editing tool appearing on said picture display unit,
said computer program comprising the steps of:
changing attributes of said editing tool; and
carrying out processing to change said information on surfaces of said 3-dimensional model serving as an object of editing in accordance with said changed attributes of said editing tool.
